(19) United States
(12) Patent Application Publication
(10) Pub. No.: US 2026/0223082 A1
(43) Pub. Date: Jul. 30, 2026

(54) METHOD AND APPARATUS FOR ENTANGLEMENT RESOURCE ALLOCATION

(71) Applicant: LG ELECTRONICS INC., Seoul (KR)

(72) Inventors: Jayeong KIM, Seoul (KR); Hojae LEE, Seoul (KR); Sangrim LEE, Seoul (KR); Byungkyu AHN, Seoul (KR); Jonghyun LEE, Seoul (KR)

(73) Assignee: LG ELECTRONICS INC., Seoul (KR)

(21) Appl. No.: 19/151,972

(22) PCT Filed: Jan. 30, 2023
(86) PCT No.: PCT/KR2023/001337

§ 371 Date: Jul. 29, 2025

(51) Int. Cl. H04W 72/044; H04W 74/0833

(52) U.S. Cl. CPC H04W 72/044; H04W 74/0833

(57) ABSTRACT

A method performed by a first node in a communication system includes receiving at least one synchronization signal from a second node, receiving system information from the second node, transmitting a random access preamble to the second node, receiving a random access response message from the second node, transmitting, to the second node, a quantum resource allocation request message including traffic characteristic information, receiving, from the second node, a quantum resource allocation response message including quantum resource allocation configuration information, receiving an allocation of a quantum resource from the second node based on a direct quantum channel, and transmitting data to a third node based on the quantum resource allocation response message and the quantum resource. The quantum resource allocation configuration information includes entanglement information or probability density coefficients of partially entangled quantum resources.

### CROSS-REFERENCE TO RELATED APPLICATION(S)

This application is the National Stage filing under 35 U.S.C. 371 of International Application No. PCT/KR2023/001337, filed on Jan. 30, 2023, the contents of which are all incorporated by reference herein in its entirety.

### TECHNICAL FIELD

The present disclosure relates to a method and apparatus for entanglement resource allocation and more particularly, to an entanglement resource allocation method and apparatus for transmitting and receiving quantum data based on probabilistic quantum teleportation.

### BACKGROUND ART

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

In the Probabilistic Quantum Teleportation (PQT) protocol, the success or failure of the teleportation process is generally determined through the Local Operation and Classical Communication (LOCC) procedure utilizing an ancillary qubit, and if the teleportation process is confirmed as successful, the unknown qubit information is teleported with a fidelity of 1. At this time, the maximum teleportation success probability achievable through the PQT protocol is determined by the probability density coefficient of the partially entangled state resource used in the PQT; in an environment where various traffic characteristics or target scenarios coexist, there is an additional need for a mechanism that adaptively manages the configuration information-including the probability density coefficient of the partially entangled state-according to the requirements of the quantum data and allocates the entanglement resources accordingly.

### DISCLOSURE

### Technical Problem

A technical object of the present disclosure relates to a method for allocating entanglement resources to support quantum data transportation using partially entangled states as quantum channels, such as in the probabilistic quantum teleportation (PQT), in a quantum communication system.

### Technical Solution

A method performed by a first node in a communication system according to an embodiment of the present disclosure may comprise receiving at least one synchronization signal from a second node, receiving system information from the second node, transmitting a random access preamble to the second node, receiving a random access response message from the second node, transmitting, to the second node, a quantum resource allocation request message including traffic characteristic information, receiving, from the second node, a quantum resource allocation response message including quantum resource allocation configuration information, receiving an allocation of a quantum resource from the second node based on a direct quantum channel, and transmitting data to a third node based on the quantum resource allocation response message and the quantum resource, wherein the quantum resource allocation configuration information may include entanglement information or probability density coefficients of partially entangled quantum resources.

The traffic characteristic information may relate to at least one of maximum outage probability or maximum delay.

The quantum resource allocation request message may further include at least one of identifier information of the first node, identifier information of the third node, or information on a transmission protocol type.

The transmitting data to the third node based on the quantum resource may transmit the data continuously based on the quantum resource.

A first node operating in a communication system according to an embodiment of the present disclosure may comprise one or more transceivers, one or more processors controlling the one or more transceivers, and one or more memories including one or more instructions performed by the one or more processors. The one or more memories may comprise receiving at least one synchronization signal from a second node, receiving system information from the second node, transmitting a random access preamble to the second node, receiving a random access response message from the second node, transmitting, to the second node, a quantum resource allocation request message including traffic characteristic information, receiving, from the second node, a quantum resource allocation response message including quantum resource allocation configuration information, receiving an allocation of a quantum resource from the second node based on a direct quantum channel, and transmitting data to a third node based on the quantum resource allocation response message and the quantum resource, and the quantum resource allocation configuration information may include entanglement information or probability density coefficients of partially entangled quantum resources.

The traffic characteristic information may relate to at least one of maximum outage probability or maximum delay.

The quantum resource allocation request message may further include at least one of identifier information of the first node, identifier information of the third node, or information on a transmission protocol type.

The transmitting data to the third node based on the quantum resource may transmit the data continuously based on the quantum resource.

A first node operating in a communication system according to an embodiment of the present disclosure may comprise one or more transceivers, one or more processors controlling the one or more transceivers, and one or more memories including one or more instructions performed by the one or more processors. The one or more memories may comprise transmitting at least one synchronization signal to a second node and a third node, transmitting system information to the second node and the third node, receiving a random access preamble from the second node and the third node, receiving a random access response message from the second node and the third node, receiving, from the second node, a quantum resource allocation response message including traffic characteristic information, determining quantum resource allocation configuration information based on the traffic characteristic information, generating a first response message and a second response message in response to the quantum resource allocation request message including the quantum resource allocation configuration information, transmitting the first response message to the second node, transmitting the second response message to the third node, generating a quantum resource based on the quantum resource allocation configuration, and allocating the quantum resource to the second node and the third node based on a direct quantum channel.

The quantum resource allocation request message may further include at least one of identifier information of the second node, identifier information of the third node, or information on a transmission protocol type.

Determining the quantum resource allocation configuration information based on the traffic characteristic information may comprise obtaining entanglement information or probability density coefficients of a quantum resource in a partially entangled state, and determining quantum resource allocation configuration information including entanglement information or probability density coefficients of a quantum resource in the partially entangled state.

Information included in the first response message and the second response message may be determined based on a transmission protocol between the second node and the third node.

The generating the quantum resource based on the quantum resource allocation configuration information may include generating the quantum resource by performing at least one of entanglement generation or entanglement concentration based on the quantum resource allocation configuration information.

A method performed by a first node in a communication system according to an embodiment of the present disclosure may comprise transmitting at least one synchronization signal to a second node and a third node, transmitting system information to the second node and the third node, receiving a random access preamble from the second node and the third node, receiving a random access response message from the second node and the third node, receiving, from the second node, a quantum resource allocation response message including traffic characteristic information, determining quantum resource allocation configuration information based on the traffic characteristic information, generating a first response message and a second response message in response to the quantum resource allocation request message including the quantum resource allocation configuration information, transmitting the first response message to the second node, transmitting the second response message to the third node, generating a quantum resource based on the quantum resource allocation configuration, and allocating the quantum resource to the second node and the third node based on a direct quantum channel.

The quantum resource allocation request message may further include at least one of identifier information of the second node, identifier information of the third node, or information on a transmission protocol type.

Determining the quantum resource allocation configuration information based on the traffic characteristic information may comprise obtaining entanglement information or probability density coefficients of a quantum resource in a partially entangled state, and determining quantum resource allocation configuration information including entanglement information or probability density coefficients of a quantum resource in the partially entangled state.

Information included in the first response message and the second response message may be determined based on a transmission protocol between the second node and the third node.

The generating the quantum resource based on the quantum resource allocation configuration information may include generating the quantum resource by performing at least one of entanglement generation or entanglement concentration based on the quantum resource allocation configuration information.

A first device according to an embodiment of the present disclosure may comprise one or more memories and one or more processors operably connected to the one or more memories. The one or more processors may operate the first device to receive at least one synchronization signal from a second node, receive system information from the second node, transmit a random access preamble to the second node, receive a random access response message from the second node, transmit, to the second node, a quantum resource allocation request message including traffic characteristic information, receive, from the second node, a quantum resource allocation response message including quantum resource allocation configuration information, receive an allocation of a quantum resource from the second node based on a direct quantum channel, and transmit data to a third node based on the quantum resource allocation response message and the quantum resource, and the quantum resource allocation configuration information may include entanglement information or probability density coefficients of partially entangled quantum resources.

One or more non-transitory computer readable mediums according to an embodiment of the present disclosure may store one or more instructions. The one or more instructions may comprise receiving at least one synchronization signal from a second node, receiving system information from the second node, transmitting a random access preamble to the second node, receiving a random access response message from the second node, transmitting, to the second node, a quantum resource allocation request message including traffic characteristic information, receiving, from the second node, a quantum resource allocation response message including quantum resource allocation configuration information, receiving an allocation of a quantum resource from the second node based on a direct quantum channel, and transmitting data to a third node based on the quantum resource allocation response message and the quantum resource, and the quantum resource allocation configuration information may include entanglement information or probability density coefficients of partially entangled quantum resources.

### Advantageous Effects

According to the present disclosure, configuration information of quantum resources suitable for the characteristics of each quantum data may be adaptively set and managed in an environment where various traffic characteristics or target scenarios coexist.

According to the present disclosure, it is possible to minimize the procedures and resources required for the generation and allocation of entanglement resources, thereby improving the resource efficiency of the entire network.

### DESCRIPTION OF THE DRAWING

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing a method of processing a transmitted signal applicable to the present disclosure.

FIG. 4 is a view showing another example of a wireless device applicable to the present disclosure.

FIG. 5 is a view showing an example of a hand-held device applicable to the present disclosure.

FIG. 6 is a view showing physical channels applicable to the present disclosure and a signal transmission method using the same.

FIG. 7 is a view showing the structure of a radio frame applicable to the present disclosure.

FIG. 8 is a view showing a slot structure applicable to the present disclosure.

FIG. 9 is a view showing an example of a communication structure providable in a 6G system applicable to the present disclosure.

FIG. 10 illustrates an example of a structure of a perceptron.

FIG. 11 illustrates an example of a structure of a multilayer perceptron.

FIG. 12 illustrates an example of a deep neural network.

FIG. 13 illustrates an example of a convolutional neural network.

FIG. 14 illustrates an example of a filter operation in a convolutional neural network.

FIG. 15 illustrates an example of a neural network structure in which a circular loop exists.

FIG. 16 illustrates an example of an operation structure of a recurrent neural network.

FIG. 17 is a view showing an electromagnetic spectrum applicable to the present disclosure.

FIG. 18 is a view showing a THz communication method applicable to the present disclosure.

FIG. 19 is a view showing a THz wireless communication transceiver applicable to the present disclosure.

FIG. 20 is a view showing a THz signal generation method applicable to the present disclosure.

FIG. 21 is a view showing a wireless communication transceiver applicable to the present disclosure.

FIG. 22 is a view showing a transmitter structure applicable to the present disclosure.

FIG. 23 is a view showing a modulator structure applicable to the present disclosure.

FIG. 24 is a conceptual view of a Bell state resource generation circuit applicable to the present disclosure.

FIG. 25 is a conceptual view of a Bell state measurement circuit applicable to the present disclosure.

FIG. 26 is a conceptual view of a quantum teleportation system applicable to the present disclosure.

FIGS. 27 to 29 are conceptual views for describing entanglement generation and distribution applicable to the present disclosure.

FIG. 30 is a conceptual view for describing a relationship between multiple imperfections affecting a reliability of a qubit transmitted through quantum teleportation applicable to the present disclosure.

FIG. 31 is a conceptual view showing a relationship between quantum channel models applicable to the present disclosure.

FIG. 32 is a conceptual view for describing a Pauli gate applicable to the present disclosure.

FIG. 33 is a conceptual view illustrating an error correction circuit of a 3-qubit bit flip code applicable to the present disclosure.

FIG. 34 is a conceptual view illustrating an error correction circuit of a 3-qubit phase flip code applicable to the present disclosure.

FIG. 35 is a conceptual view showing an error correction circuit of a Shor code applicable to the present disclosure.

FIGS. 36 to 37 are conceptual diagrams illustrating probabilistic quantum teleportation.

FIG. 38 is a diagram of a quantum communication system according to one embodiment of the present disclosure.

FIG. 39 is a conceptual diagram of a quantum resource allocation request message according to one embodiment of the present disclosure.

FIG. 40 is a conceptual diagram of a quantum resource allocation response message according to one embodiment of the present disclosure.

FIG. 41 is a flowchart of a quantum communication method according to one embodiment of the present disclosure.

FIG. 42 is a conceptual diagram illustrating PQT transmission according to one embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

Communication system applicable to the present disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

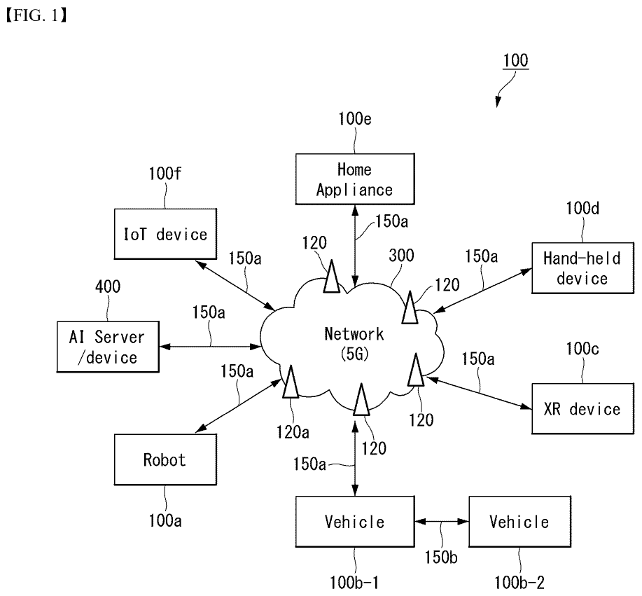

FIG. 1 is a view showing an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

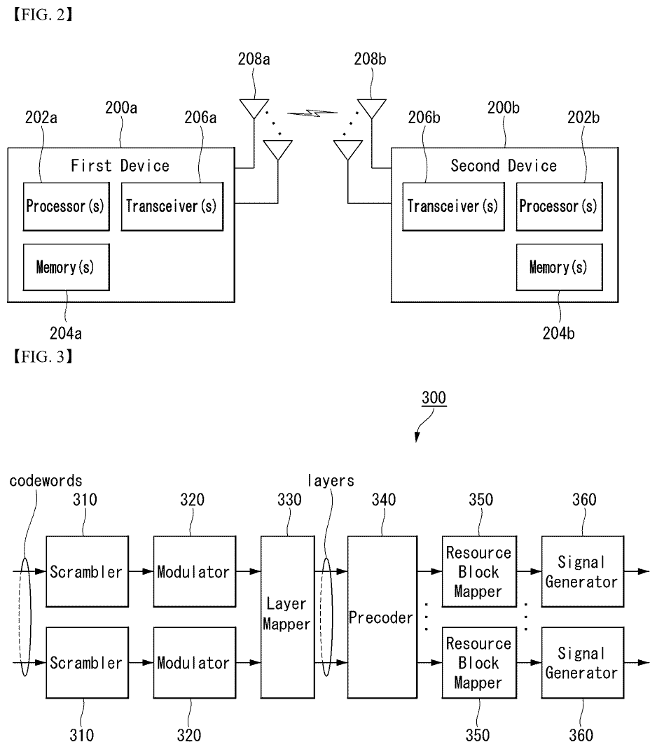

FIG. 3 is a view showing a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 310 to 350 may be implemented in the processors 202a and 202b of FIG. 2 and a block 360 may be implemented in the transceivers 206a and 206b of FIG. 2, without being limited to the above-described embodiments.

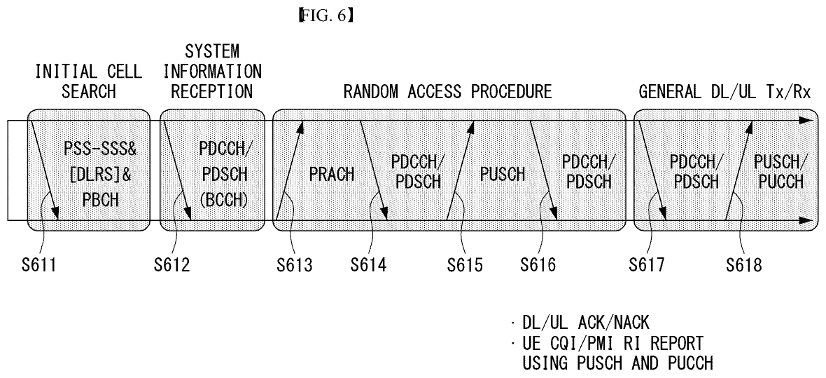

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

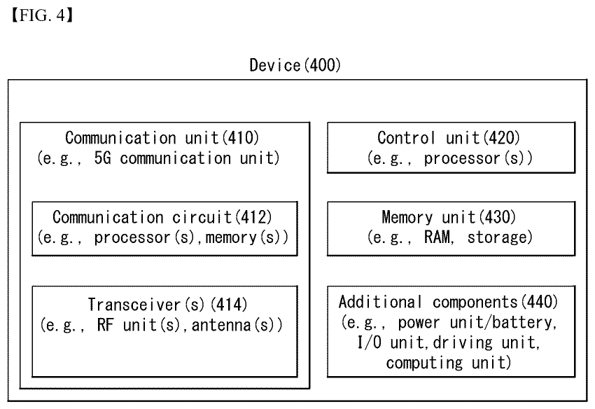

FIG. 4 is a view showing another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 300 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

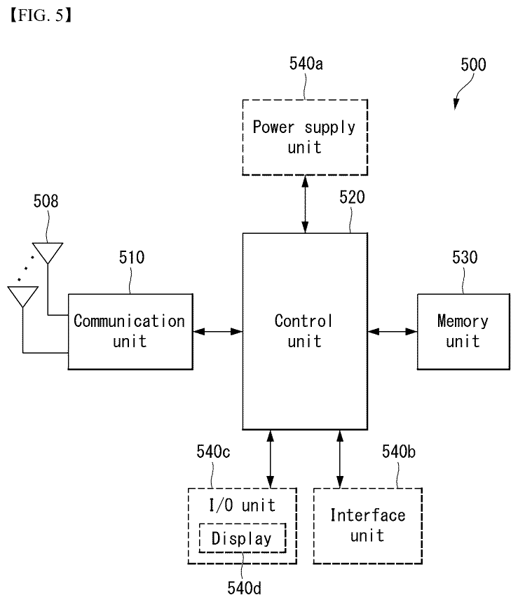

FIG. 5 is a view showing an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 400 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 400. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

Physical channels and general signal transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 is a view showing physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

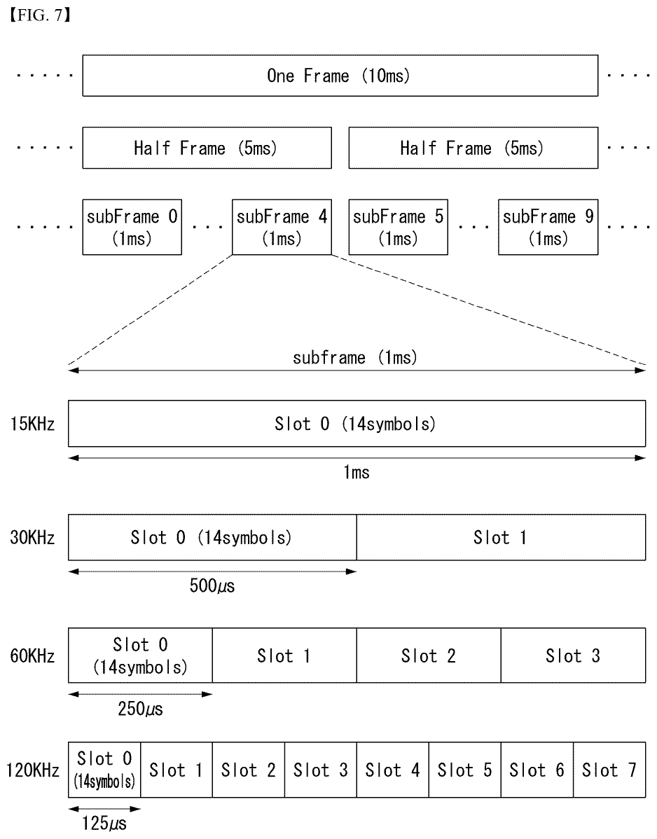

FIG. 7 is a view showing the structure of a radio frame applicable to the present disclosure. UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM (A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In Tables 1 and 2 above, N^{slot}_{symb} may indicate the number of symbols in a slot, N^{frame,μ}ₛₗₒₜ may indicate the number of slots in a frame, and N^{subframe,μ}ₛₗₒₜ may indicate the number of slots in a subframe.

In addition, in a system, to which the present disclosure is applicable, OFDM (A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

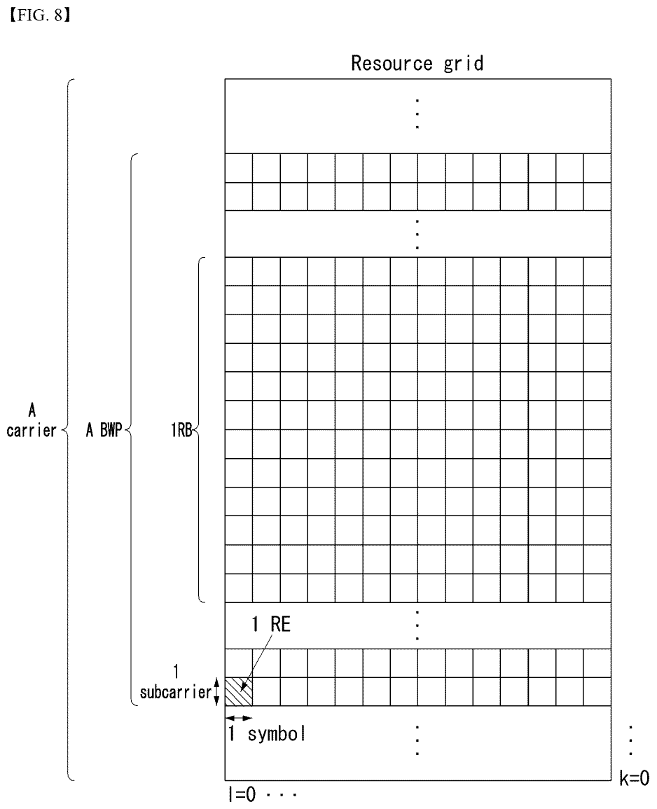

FIG. 8 is a view showing a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P) RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

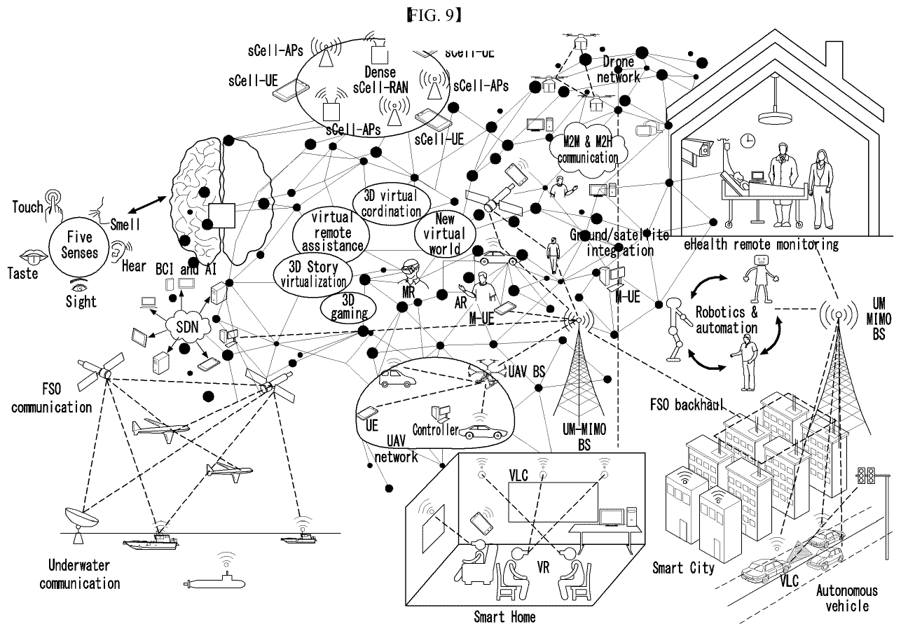

FIG. 9 is a view showing an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Core Implementation Technology of 6G System

Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

An artificial neural network is an example in which multiple perceptrons are connected.

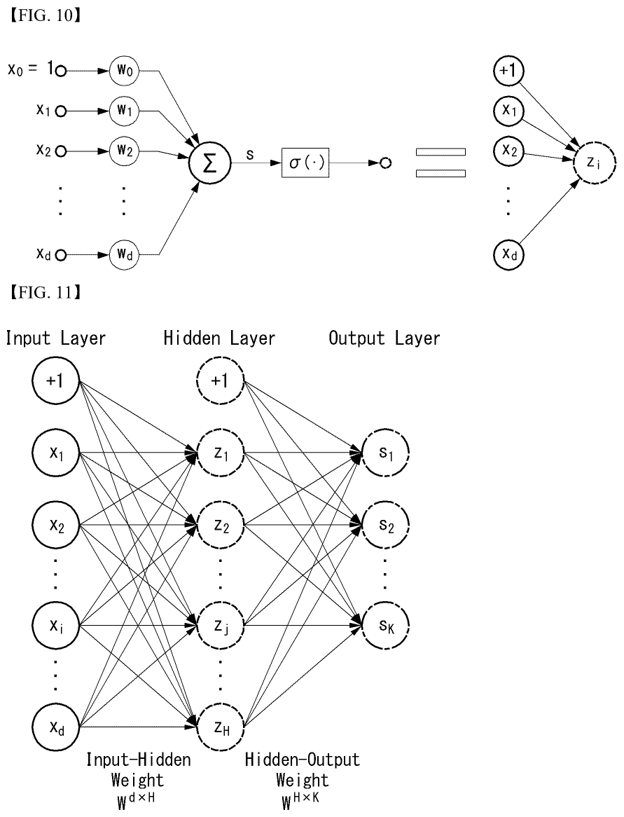

FIG. 10 illustrates an example of a structure of a perceptron.

Referring to FIG. 10, when an input vector x=(x1, x2, . . . , xd) is input, each component is multiplied by a weight (W1, W2, . . . , Wd), and all the results are summed. After that, the entire process of applying an activation function σ(·) is called a perceptron. The huge artificial neural network structure may extend the simplified perceptron structure illustrated in FIG. 10 to apply the input vector to different multidimensional perceptrons. For convenience of explanation, an input value or an output value is referred to as a node.

The perceptron structure illustrated in FIG. 10 may be described as consisting of a total of three layers based on the input value and the output value. FIG. 11 illustrates an artificial neural network in which the number of (d+1) dimensional perceptrons between a first layer and a second layer is H, and the number of (H+1) dimensional perceptrons between the second layer and a third layer is K, by way of example. FIG. 11 illustrates an example of a structure of a multilayer perceptron.

A layer where the input vector is located is called an input layer, a layer where a final output value is located is called an output layer, and all layers located between the input layer and the output layer are called a hidden layer. FIG. 11 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

The deep neural network illustrated in FIG. 12 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the plurality of perceptrons are connected to each other, various artificial neural network structures different from the above-described DNN can be formed.

In the DNN, nodes located inside one layer are arranged in a one-dimensional longitudinal direction. However, in FIG. 13, it may be assumed that w nodes horizontally and h nodes vertically are arranged in two dimensions (convolutional neural network structure of FIG. 13). In this case, since in a connection process leading from one input node to the hidden layer, a weight is given for each connection, a total of h×w weights needs to be considered. Since there are h×w nodes in the input layer, a total of h2w2 weights are required between two adjacent layers.

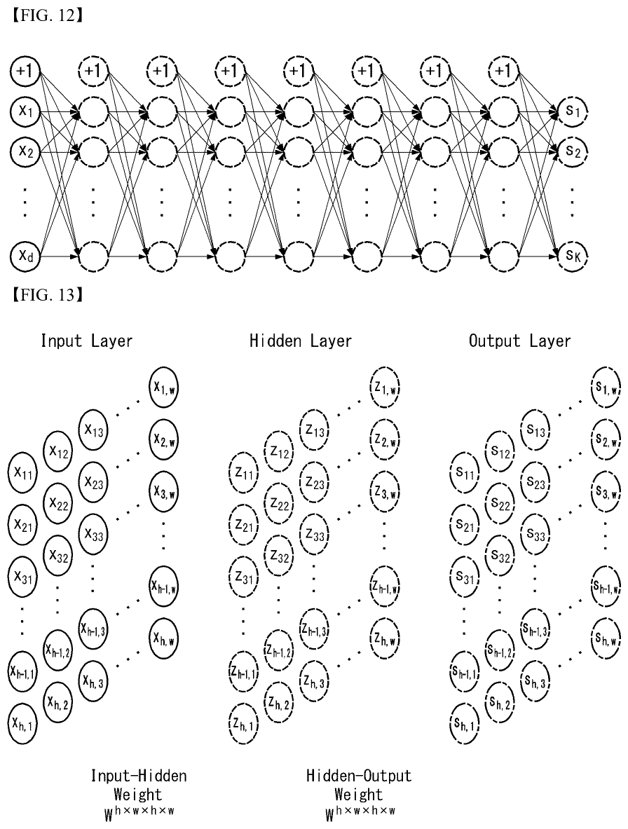

The convolutional neural network of FIG. 13 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 14.

One filter has a weight corresponding to the number as much as its size, and learning of the weight may be performed so that a certain feature on an image can be extracted and output as a factor. In FIG. 14, a filter having a size of 3×3 is applied to the upper leftmost 3×3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

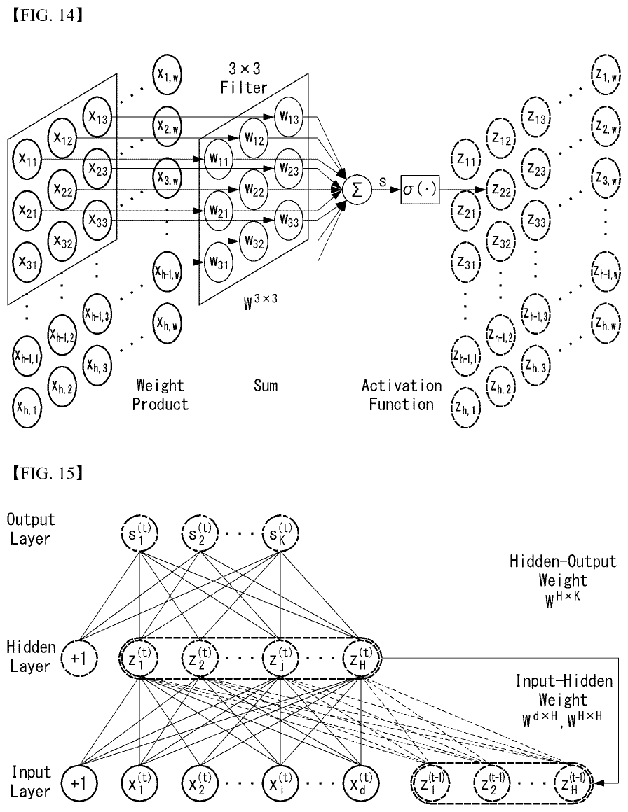

FIG. 15 illustrates an example of a neural network structure in which a circular loop exists.

Referring to FIG. 15, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

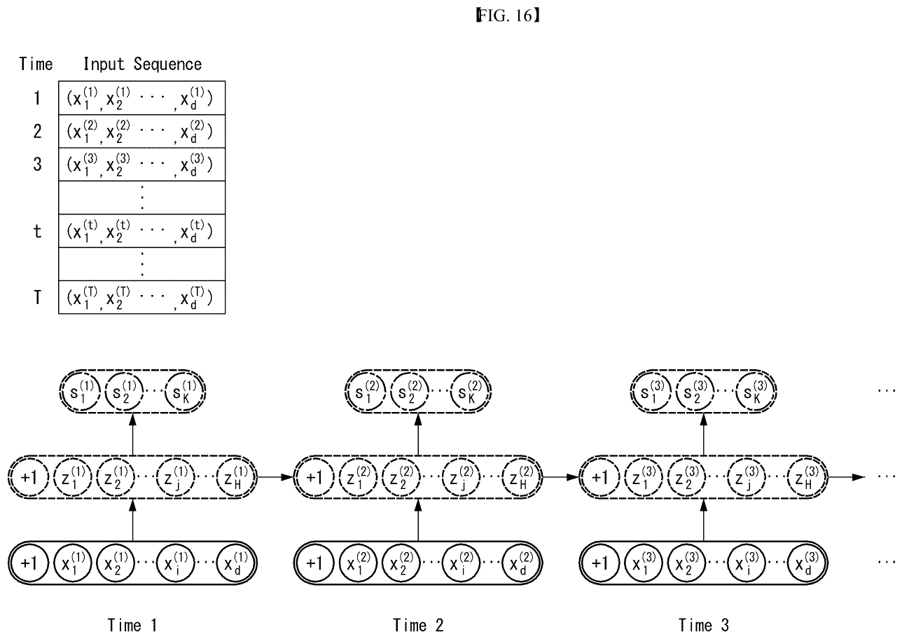

FIG. 16 illustrates an example of an operation structure of a recurrent neural network.

Referring to FIG. 16, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 Care input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, nay be included.

### Terahertz (THz) Communication

THz communication is applicable to the 6G system. For example, a data rate may increase by increasing bandwidth. This may be performed by using sub-TH communication with wide bandwidth and applying advanced massive MIMO technology.

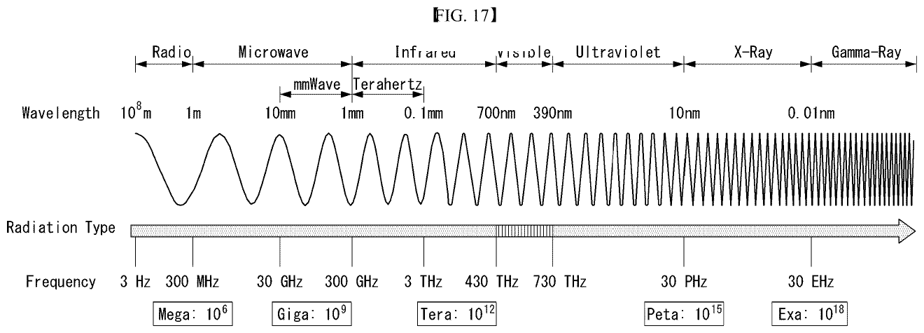

FIG. 17 is a view showing an electromagnetic spectrum applicable to the present disclosure. For example, referring to FIG. 17, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Optical Wireless Technology

Optical wireless communication (OWC) technology is planned for 6G communication in addition to RF based communication for all possible device-to-access networks. This network is connected to a network-to-backhaul/fronthaul network connection. OWC technology has already been used since 4G communication systems but will be more widely used to satisfy the requirements of the 6G communication system. OWC technologies such as light fidelity/visible light communication, optical camera communication and free space optical (FSO) communication based on wide band are well-known technologies. Communication based on optical wireless technology may provide a very high data rate, low latency and safe communication. Light detection and ranging (LiDAR) may also be used for ultra high resolution 3D mapping in 6G communication based on wide band.

### FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

### Massive MIMO Technology

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

### Blockchain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

### 3D Networking

The 6G system integrates terrestrial and public networks to support vertical expansion of user communication. A 3D BS will be provided through low-orbit satellites and UAVs. Adding new dimensions in terms of altitude and related degrees of freedom makes 3D connections significantly different from existing 2D networks.

### Quantum Communication

In the context of the 6G network, unsupervised reinforcement learning of the network is promising. The supervised learning method cannot label the vast amount of data generated in 6G. Labeling is not required for unsupervised learning. Thus, this technique can be used to autonomously build a representation of a complex network. Combining reinforcement learning with unsupervised learning may enable the network to operate in a truly autonomous way.

### Unmanned Aerial Vehicle

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Cell-Free Communication

The tight integration of multiple frequencies and heterogeneous communication technologies is very important in the 6G system. As a result, a user can seamlessly move from network to network without having to make any manual configuration in the device. The best network is automatically selected from the available communication technologies. This will break the limitations of the cell concept in wireless communication. Currently, user movement from one cell to another cell causes too many handovers in a high-density network, and causes handover failure, handover delay, data loss and ping-pong effects. 6G cell-free communication will overcome all of them and provide better QoS. Cell-free communication will be achieved through multi-connectivity and multi-tier hybrid technologies and different heterogeneous radios in the device.

### Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

### Integration of Sensing and Communication

An autonomous wireless network is a function for continuously detecting a dynamically changing environment state and exchanging information between different nodes. In 6G, sensing will be tightly integrated with communication to support autonomous systems.

### Integration of Access Backhaul Network

In 6G, the density of access networks will be enormous. Each access network is connected by optical fiber and backhaul connection such as FSO network. To cope with a very large number of access networks, there will be a tight integration between the access and backhaul networks.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Large Intelligent Surface (LIS)

In the case of the THz band signal, since the straightness is strong, there may be many shaded areas due to obstacles. By installing the LIS near these shaded areas, LIS technology that expands a communication area, enhances communication stability, and enables additional optional services becomes important. The LIS is an artificial surface made of electromagnetic materials, and can change propagation of incoming and outgoing radio waves. The LIS can be viewed as an extension of massive MIMO, but differs from the massive MIMO in array structures and operating mechanisms. In addition, the LIS has an advantage such as low power consumption, because this operates as a reconfigurable reflector with passive elements, that is, signals are only passively reflected without using active RF chains. In addition, since each of the passive reflectors of the LIS must independently adjust the phase shift of an incident signal, this may be advantageous for wireless communication channels. By properly adjusting the phase shift through an LIS controller, the reflected signal can be collected at a target receiver to boost the received signal power.

### THz Wireless Communication

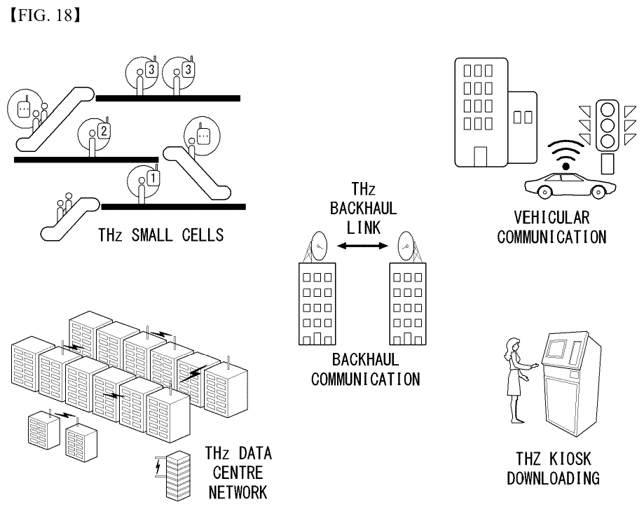

FIG. 18 is a view showing a THz communication method applicable to the present disclosure.

Referring to FIG. 18, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

In addition, the photon energy of the THz wave is only a few meV and thus is harmless to the human body. A frequency band which will be used for THz wireless communication may be a D-band (110 GHz to 170 GHz) or a H-band (220 GHz to 325 GHz) band with low propagation loss due to molecular absorption in air. Standardization discussion on THz wireless communication is being discussed mainly in IEEE 802.15 THz working group (WG), in addition to 3GPP, and standard documents issued by a task group (TG) of IEEE 802.15 (e.g., TG3d, TG3e) specify and supplement the description of this disclosure. The THz wireless communication may be applied to wireless cognition, sensing, imaging, wireless communication, and THz navigation.

Specifically, referring to FIG. 18, a THz wireless communication scenario may be classified into a macro network, a micro network, and a nanoscale network. In the macro network, THz wireless communication may be applied to vehicle-to-vehicle (V2V) connection and backhaul/fronthaul connection. In the micro network, THz wireless communication may be applied to near-field communication such as indoor small cells, fixed point-to-point or multi-point connection such as wireless connection in a data center or kiosk downloading. Table 5 below shows an example of technology which may be used in the THz wave.

TABLE 5

| | |
|---|---|
| Transceivers Device | Available immature: UTC-PD, RTD and SBD |
| Modulation and coding | Low order modulation techniques (OOK, QPSK), |
| | LDPC, Reed Soloman, Hamming, Polar, Turbo |
| Antenna | Omni and Directional, phased array with |
| | low number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

FIG. 19 is a view showing a THz wireless communication transceiver applicable to the present disclosure.

Referring to FIG. 19, THz wireless communication may be classified based on the method of generating and receiving THz. The THz generation method may be classified as an optical device or electronic device based technology.

At this time, the method of generating THz using an electronic device includes a method using a semiconductor device such as a resonance tunneling diode (RTD), a method using a local oscillator and a multiplier, a monolithic microwave integrated circuit (MMIC) method using a compound semiconductor high electron mobility transistor (HEMT) based integrated circuit, and a method using a Si-CMOS-based integrated circuit. In the case of FIG. 19, a multiplier (doubler, tripler, multiplier) is applied to increase the frequency, and radiation is performed by an antenna through a subharmonic mixer. Since the THz band forms a high frequency, a multiplier is essential. Here, the multiplier is a circuit having an output frequency which is N times an input frequency, and matches a desired harmonic frequency, and filters out all other frequencies. In addition, beamforming may be implemented by applying an array antenna or the like to the antenna of FIG. 19. In FIG. 19, IF represents an intermediate frequency, a tripler and a multiplier represents a multiplier, PA represents a power amplifier, and LNA represents a low noise amplifier, and PLL represents a phase-locked loop.

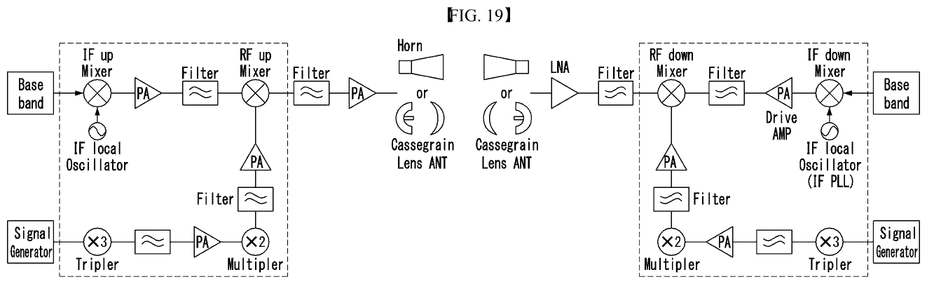

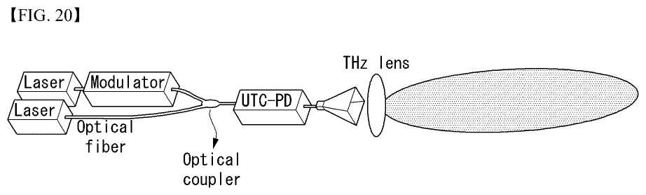

FIG. 20 is a view showing a THz signal generation method applicable to the present disclosure FIG. 21 is a view showing a wireless communication transceiver applicable to the present disclosure.

Referring to FIGS. 20 and 21, the optical device-based THz wireless communication technology means a method of generating and modulating a THz signal using an optical device. The optical device-based THz signal generation technology refers to a technology that generates an ultrahigh-speed optical signal using a laser and an optical modulator, and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the THz signal based on the optical device, as shown in FIG. 20, a laser diode, a broadband optical modulator, and an ultrahigh-speed photodetector are required. In the case of FIG. 20, the light signals of two lasers having different wavelengths are combined to generate a THz signal corresponding to a wavelength difference between the lasers. In FIG. 20, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 21, an erbium-doped fiber amplifier (EDFA) represents an optical fiber amplifier to which erbium is added, a photo detector (PD) represents a semiconductor device capable of converting an optical signal into an electrical signal, and OSA represents an optical sub assembly in which various optical communication functions (e.g., photoelectric conversion, electrophonic conversion, etc.) are modularized as one component, and DSO represents a digital storage oscilloscope.

FIG. 22 is a view showing a transmitter structure applicable to the present disclosure. FIG. 23 is a view showing a modulator structure applicable to the present disclosure.

Referring to FIGS. 22 and 23, generally, the optical source of the laser may change the phase of a signal by passing through the optical wave guide. At this time, data is carried by changing electrical characteristics through microwave contact or the like. Thus, the optical modulator output is formed in the form of a modulated waveform. A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the device.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

Here, wireless communication technology implemented in the wireless devices 200a and 200b of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices of the present disclosure may perform communication based on LTE-M technology. In this case, as an example, the LTE-M technology may be an example of the LPWAN and may be called various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M. Additionally or alternatively, the wireless communication technology implemented in the wireless devices 200a and 200b of the present disclosure may include at least one of ZigBee, Bluetooth, and Low Power Wide Area Network (LPWAN) considering the low-power communication, and is not limited to the name described above. As an example, the ZigBee technology may generate personal area networks (PAN) associated with small/low-power digital communication based on various standards including IEEE 802.15.4, and the like, and may be called various names.

The contents described above may be applied in combination with embodiments proposed in the present disclosure to be described below or may be supplemented to clarify technical features of the embodiments proposed in the present disclosure. Embodiments to be described below are just distinguished for convenience of description and it is needless to say that some components of any one embodiment may be substituted with some components of another embodiment or may be applied in combination with each other.

### 1. Bell State and Bell Basis

A Bell state resource may be a simplest quantum state that two qubits may achieve and a state with greatest quantum entanglement. The Bell state resource may be viewed as a maximally entangled basis for a four-dimensional Hilbert space for qubits, and is called a Bell basis. The Bell state resource may be represented as Equations 1 to 4 below.

$$\vert {ϕ}^{+} 〉 = \frac{1}{\sqrt{2}} ( \vert {0}_{A} {0}_{B} 〉 ) + \vert {1}_{A} {1}_{B} 〉 ) \qquad [ Equation 1 ]$$

$$\vert {ϕ}^{-} 〉 = \frac{1}{\sqrt{2}} ( \vert {0}_{A} {0}_{B} 〉 ) - \vert {1}_{A} {1}_{B} 〉 ) \qquad [ Equation 2 ]$$

$$\vert {ψ}^{+} 〉 = \frac{1}{\sqrt{2}} ( \vert {0}_{A} {0}_{B} 〉 ) + \vert {1}_{A} {1}_{B} 〉 ) \qquad [ Equation 3 ]$$

$$\vert {ψ}^{-} 〉 = \frac{1}{\sqrt{2}} ( \vert {0}_{A} {0}_{B} 〉 ) - \vert {1}_{A} {1}_{B} 〉 ) \qquad [ Equation 4 ]$$

In Equations 1 to 4, |φ⁺ [symbol] , |Ψ⁺ [symbol] , φ⁻ and Ψ⁻ may be Bell state resources which two qubits may achieve.

### 2. Generation of Bell State Resource

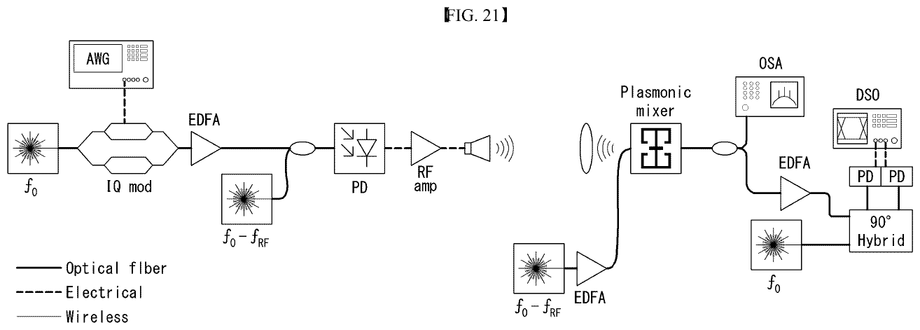

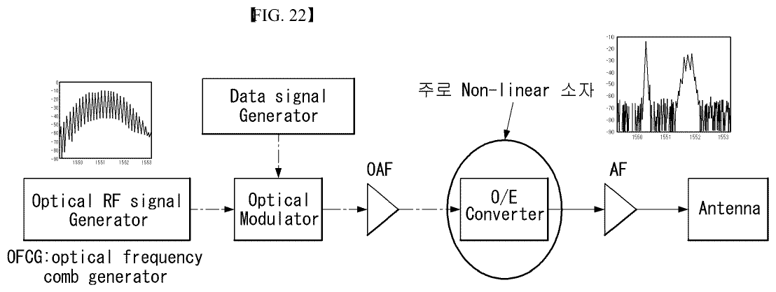

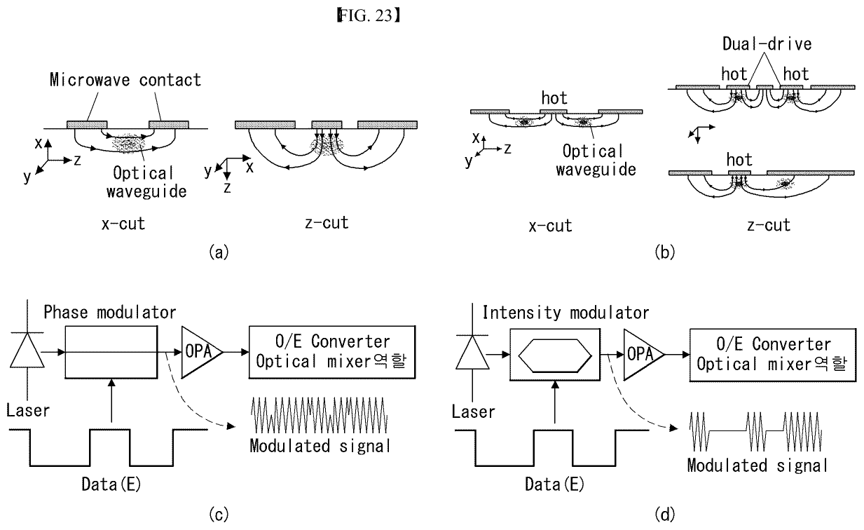

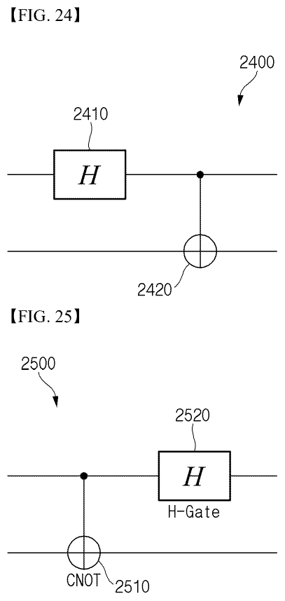

FIG. 24 is a conceptual view of a Bell state resource generation circuit applicable to the present disclosure.

Referring to FIG. 24, the Bell state resource generation circuit 2400 may include a Hadamard gate 2410 and a controlled not (CNOT) gate 2420. The Bell state resource generation circuit 2400 may be a quantum circuit for generating Bell state resources. The Bell state resource generation circuit may generate a Bell state resource based on two qubits. When inputs of the Bell state resource generation circuit 2400 are 00, 01, 10, and 11, respectively, as qubits included in the two, outputs of the Bell state resource generation circuit 2400 may be 1φ⁺ [symbol] , |Ψ⁺ [symbol] , φ⁻ and Ψ⁻, respectively, and when this is expressed in a single table, the outputs may be as shown in Table 6.

TABLE 6

| Input (two-qubit) | Output (Bell state) |
|---|---|
| 00 | $\vert {ϕ}^{+} 〉 = \vert {B}_{00} 〉 = \frac{1}{\sqrt{2}} ( \vert {0}_{A} {0}_{B} 〉 + \vert {1}_{A} {1}_{B} 〉 )$ |
| 01 | $\vert {ψ}^{+} 〉 = \vert {B}_{01} 〉 = \frac{1}{\sqrt{2}} ( \vert {0}_{A} {1}_{B} 〉 + \vert {1}_{A} {0}_{B} 〉 )$ |
| 10 | $\vert {ϕ}^{-} 〉 = \vert {B}_{10} 〉 = \frac{1}{\sqrt{2}} ( \vert {0}_{A} {0}_{B} 〉 - \vert {1}_{A} {1}_{B} 〉 )$ |
| 11 | $\vert {ψ}^{-} 〉 = \vert {B}_{11} 〉 = \frac{1}{\sqrt{2}} ( \vert {0}_{A} {1}_{B} 〉 - \vert {1}_{A} {0}_{B} 〉 )$ |

### 3. Bell State Measurement/Bell State Analysis

The Bell state measurement or the Bell state resource analysis may mean identifying the Bell state resources of two qubits. The Bell state measurement or the Bell state resource analysis may be capable of forming an orthonormal basis for Bell state resources. The Bell state measurement or the Bell state resource analysis nay be used to find out which of the four quantum entanglement states the states of the qubits included in two are.

FIG. 25 is a conceptual view of a Bell state measurement circuit applicable to the present disclosure.

Referring to FIG. 25, the Bell state measurement circuit 2500 may include a CNOT gate 2510 and a Hadamard gate 2520. The Bell state measurement circuit 2500 may be configured in reverse to the Bell state resource generation circuit 2400 shown in FIG. 24. When inputs of the Bell state measurement circuit 2500 are |φ⁺ [symbol] , |Ψ⁺ [symbol] , φ⁻ and Ψ⁻, respectively, outputs of the Bell state measurement circuit 2500 may be 00, 01, 10, and 11, respectively, as qubits included in two, and when this is expressed in a single table, the outputs may be as shown in Table 7 below.

TABLE 7

| Input (Bell state) | Output (two-qubit) |
|---|---|
| $\vert {ϕ}^{+} 〉 = \vert {B}_{00} 〉 = \frac{1}{\sqrt{2}} ( \vert {0}_{A} {0}_{B} 〉 + \vert {1}_{A} {1}_{B} 〉 )$ | 00 |
| $\vert {ψ}^{+} 〉 = \vert {B}_{01} 〉 = \frac{1}{\sqrt{2}} ( \vert {0}_{A} {1}_{B} 〉 + \vert {1}_{A} {0}_{B} 〉 )$ | 01 |
| $\vert {ϕ}^{-} 〉 = \vert {B}_{10} 〉 = \frac{1}{\sqrt{2}} ( \vert {0}_{A} {0}_{B} 〉 - \vert {1}_{A} {1}_{B} 〉 )$ | 10 |
| $\vert {ψ}^{-} 〉 = \vert {B}_{11} 〉 = \frac{1}{\sqrt{2}} ( \vert {0}_{A} {1}_{B} 〉 - \vert {1}_{A} {0}_{B} 〉 )$ | 11 |

### 4. Quantum Teleportation

The quantum teleportation is a technology that allows a sender at a specific location to transmit quantum information to a receiver at a predetermined distance away. Contrary to an original meaning of a word ‘teleport’, in quantum teleportation, carriers of the sender and the receiver are fixed, and transmission of quantum information occurs between the carriers. Teleportation of this information requires an entangled quantum state, or a Bell state resource, which is used to impart statistical correlations between separate physical systems. Since every change that one particle undergoes causes the other particle to undergo the same change, the two particles may behave as if they were in a single quantum state.

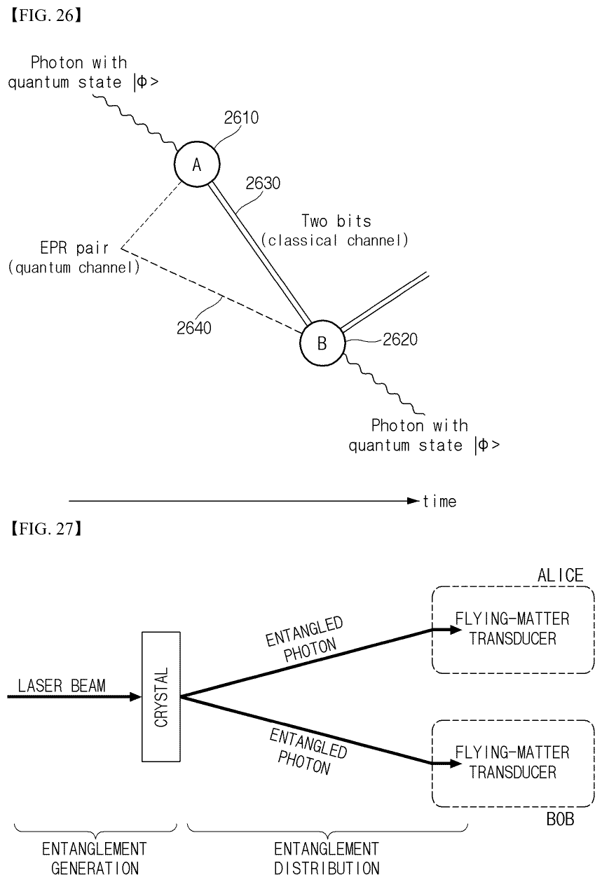

FIG. 26 is a conceptual view of a quantum teleportation system applicable to the present disclosure.

Referring to FIG. 26, the quantum teleportation system 2600 may include a transmitting terminal 2610, a receiving terminal 2620, a classical channel 2630, and a quantum channel 2640. The transmitting terminal 2610 may be Alice (A), the receiving terminal 2620 may be Bob (B), the classical channel 2630 may be a channel for the transmitting terminal 2610 to transmit two classical bits to the receiving terminal 2620, and the quantum channel may be a channel for the transmitting terminal 2610 to transmit two particles in a Bell state resource to the receiving terminal 2620. Further, although not shown in FIG. 26, the quantum teleportation system 2600 may further include a Bell state resource (entanglement state) generation device and a Bell state measurement device. A protocol of the quantum teleportation system 2600 for quantum information |φ [symbol] which the transmitting terminal 2610 intends to transmit to the receiving terminal 2620 may be as follows.
1) Entanglement generation: An entanglement state of two qubits is generated through the Bell state resource generation device.
2) Entanglement distribution: Any one of the two qubits in the generated entanglement state may move to the transmitting terminal 2610 through the quantum channel, and the qubit included in the remaining one may move to the receiving terminal 2620.

Quantum pre-processing: The transmitting terminal 2610 may perform the Bell state measurement for a quantum state |φ [symbol] to be transmitted and one qubit in an entanglement state which the transmitting terminal 2610 has. A Bell state measurement result of the transmitting terminal 2610 may be any one of |φ⁺ [symbol] , |Ψ⁺ [symbol] , φ⁻ and Ψ⁻. A qubit included in the receiving terminal 2620 according to the Bell state measurement result of the transmitting terminal 2610 may be shown as in Table 8 below.

TABLE 8

| BSM results of \|φ [symbol] and Alice's qubit | Bob's qubit |
|---|---|
| \|φ⁺ [symbol] | α\|0 [symbol] _{B} β\|1 [symbol] _{B} |
| \|φ⁻ [symbol] | α\|0 [symbol] _{B} β\|1 [symbol] _{B} |
| \|ψ⁺ [symbol] | α\|1 [symbol] _{B} β\|0 [symbol] _{B} |
| \|ψ⁻ [symbol] | α\|1 [symbol] _{B} β\|0 [symbol] _{B} |

4) Classical information transmission: The transmitting terminal 2610 may encode the Bell state measurement result into classical bits of two bits. The transmitting terminal 2620 may transmit the classical bits to the receiving terminal 2620 through the classical channel 2630.
5) Quantum post-processing: The receiving terminal 2620 may receive the classical bits from the transmitting terminal 2610 through the classical channel 2630. The receiving terminal 2620 may take a unitary operation for the remaining one bit in the entanglement state which the receiving terminal 2620 has. The receiving terminal 2620 may acquire the same quantum state as quantum information |φ [symbol] which the transmitting terminal 2610 intends to transmit.

### 5. Entanglement Generation and Distribution

An entanglement generation and distribution function may be a core element of the quantum teleportation. The transmitting terminal and the receiving terminal may be located at a large distance from each other. Therefore, entanglement generation which occurs at any one location may be complemented by an entanglement distribution function that “shifts” one of the entangled particles to the other. For this purpose, flying qubits, which are photons, may be used as entanglement carriers. Photons may have an advantage of exhibiting moderate decoherence properties due to their relatively low interaction with an environment, allowing for high-speed transmission, and being easily controlled using standard optical components.

FIGS. 27 to 29 are conceptual views for describing entanglement generation and distribution applicable to the present disclosure.

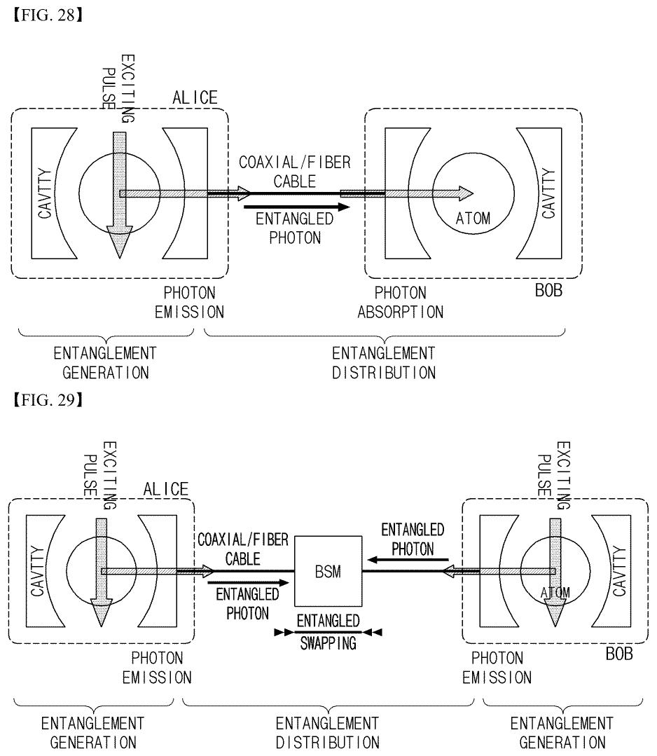

FIG. 27 is a view for describing entanglement generation and distribution using a spontaneous parameter down-conversion scheme. FIG. 28 is a view for describing entanglement generation and distribution using an optical resonator at the transmitting terminal. FIG. 29 is a view for describing entanglement generation and distribution using the optical resonator at the transmitting terminal and the receiving terminal.

Referring to FIG. 27, when a photon beam (LASER BEAM) is projected onto a nonlinear crystal (CRYSTAL), the photon beam may be split into two entangled photon pairs (entanglement generation). Polarizations of two entangled photon pairs may be opposite. One of the two entangled photon pairs may move to a transmitting terminal (ALICE) and the other one may move to a receiving terminal (BOB) (entanglement distribution). Each of the transmitting terminal and the receiving terminal may receive photons. The transmitting terminal and the receiving terminal may convert the received photons into matter qubits by using a flying-matter transducer.

Referring to FIG. 28, a laser pulse may be irradiated inside an optical cavity on the transmitting terminal side. This allows atoms inside the optical cavity to be excited, and the excited atoms may be emitted outside the optical cavity (entanglement generation). The atoms may be incident inside the optical cavity at the receiving terminal side (entanglement distribution). In this scheme, entanglement between atoms and photons is first generated, and then converted into entanglement between atoms through photons.

Referring to FIG. 28, the laser pulse may be irradiated inside the optical cavity on the transmitting terminal side and the optical cavity on the receiving terminal side. This allows each of the atoms inside the optical cavity on the transmitting terminal side and the optical cavity on the receiving terminal side to be excited, and the excited atoms may then be emitted outside the optical cavity (entanglement generation). The emitted atoms may be incident on a beam splitter (BSM), and entanglement swapping may be performed (entanglement distribution). In this scheme, the entanglement between atoms and photons may be converted into entanglement between atoms and atoms by using the entanglement swapping.

From the viewpoint of a location where entanglement is generated, there is a difference in that FIG. 27 generates entanglement at a midpoint, FIG. 28 generates entanglement at the transmitting terminal, and FIG. 29 generates entanglement at both the transmitting terminal and the receiving terminal, but all three schemes require the quantum channel because the entanglement state is transmitted via a photon, which is a flying qubit, and the form of entanglement that is ultimately distributed may be entanglement between atoms. The schemes shown in FIGS. 27 to 29 have in common that they are forms of entanglement between material qubits that are easy to process and store information.

### 6. Imperfection Involved in Quantum Teleportation Process

Similar to classical communication, quantum communication processes may also be affected by the quality of the information transmitted due to imperfections that exist in real-world environments. The quantum teleportation system of FIG. 26 represents the quantum teleportation process in an ideal environment as a closed physical system, but in a practical quantum teleportation process, the quantum teleportation system must be represented as an open physical system because the quantum teleportation system is affected by unwanted interactions with the surrounding environment. This interaction with the environment causes an irreversible change in the quantum state, a process called decoherence. This decoherence process may affect not only an unknown quantum state transfer process, but also the entanglement generation and distribution process that must precede quantum teleportation. Another cause of imperfection involved in the quantum teleportation process is a series of quantum operations performed on the quantum state. Contamination of the quantum operation process may be a factor that worsens the imperfection of the quantum teleportation.

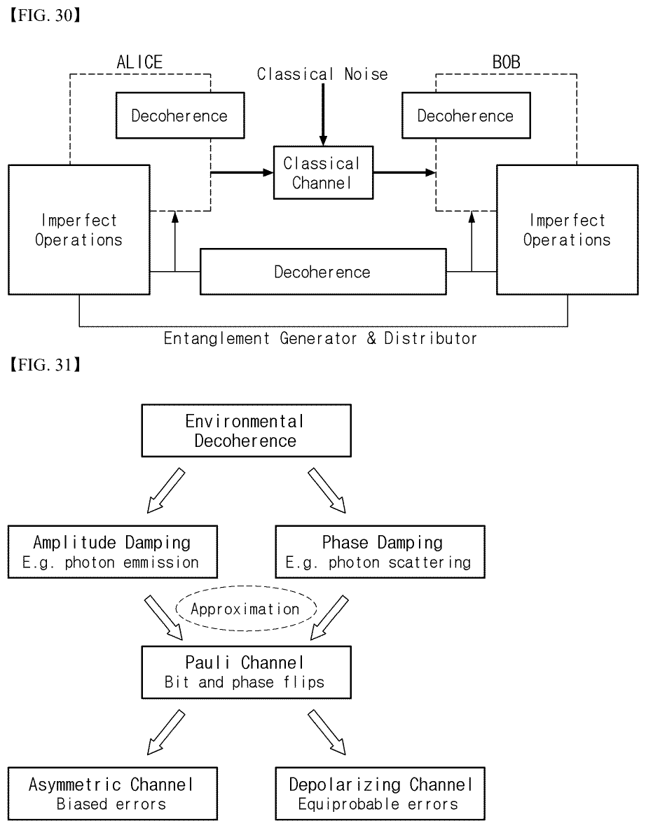

FIG. 30 is a conceptual view for describing a relationship between multiple imperfections affecting a reliability of a qubit transmitted through quantum teleportation applicable to the present disclosure.

Referring to FIG. 30, the imperfection inherent in the quantum system may transform a pure quantum state into a mixed quantum state. This may be unrelated to the cause of the imperfection.

### 7. Quantum Decoherence and Quantum Channel Model

Environmental decoherence may be a major cause of quantum state corruption. The environmental decoherence may occur not only in a quantum memory but also during quantum transport or quantum processing.

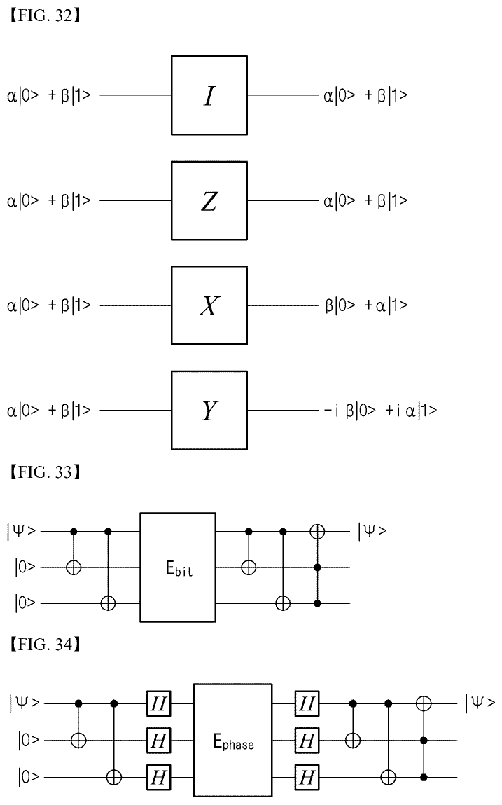

FIG. 31 is a conceptual view showing a relationship between quantum channel models applicable to the present disclosure. FIG. 32 is a conceptual view for describing a Pauli gate applicable to the present disclosure.

Referring to FIG. 31, the environmental decoherence may be described by unwanted interactions between qubits and the environment. The environmental decoherence may be described as entanglement. The environmental decoherence may disrupt a coherent superposition of fundamental quantum states.

As an example of the environmental decoherence, the qubit (or quantum system) may lose energy due to interactions with the environment. Qubits may lose energy due to interactions with their environment, when an excited state of a qubit decays due to spontaneous emission of a photon, or when the photon is lost or absorbed during transmission through an optical fiber. Such environmental decoherence may be modeled via an amplitude damping channel.

Another example of the environmental decoherence is that qubits may not lose energy, but their quantum information may be lost due to interactions with the environment, and in the case of such as scattering of photons, perturbation of electronic states due to stray charges, etc., the qubits may lose only their quantum information without losing energy. Such environmental decoherence may be modeled via dephasing or phase damping.

However, an amplitude damping channel or phase damping channel model may make a resulting system have a 2^{N}-dimensional Hilbert space for an N-qubit system. Therefore, it may be impossible to classically simulate these channels.

Referring to FIG. 32, the amplitude and phase damping channels may be approximated as Pauli channels for an efficient classical simulation. The Pauli channel may be represented as in Equation 5 below.

$${N}_{P} ( ρ ) = ( 1 - {p}_{z} - {p}_{x} - {p}_{y} ) I ρ I + {p}_{z} Z ρ Z + {p}_{x} X ρ X + {p}_{y} Y ρ Y \qquad [ Equation 5 ]$$

In Equation 5, N_{P} (ρ) may be a Pauli channel when a density operator is ρ, I, X, Y and Z may correspond to single-qubit Pauli operators of FIG. 32, and pₓ, p_{y} and p_{z} may mean a probability that Pauli X, Pauli Y, and Pauli Z errors will occur. A bit flip error corresponding to the Pauli X channel and a bit-phase flip error corresponding to the Pauli Y channel may be related to amplitude demapping, while a phase-flip error corresponding to the Pauli Z channel may be related to phase demapping.

A most practical quantum system as an asymmetric channel may be a channel in which either the bit flip error, the phase-flip error, or the bit-phase-flip error predominates. A Pauli channel in a special case where the bit flip error, the phase-flip error, and the bit-phase flip error occur at the same probability (pₓ=p_{y}=p_{z}) may be referred to as a depolarizing channel. The depolarizing channel may be represented as in Equation 6 below.

$${N}_{DP} ( ρ ) = ( 1 - p ) I ρ I + \frac{p}{3} ( Z ρ Z + X ρ X + Y ρ Y ) \qquad [ Equation 6 ]$$

In Equation 6, N_{DP}(ρ) may be a depolarizing channel when the density operator is <ρ.

### 8. Quantum Error Correction Technique

### 3-Qubit Bit Flip Error Code

FIG. 33 is a conceptual view showing an error correction circuit of a 3-qubit bit flip code applicable to the present disclosure.

Referring to FIG. 33, the 3-qubit bit flip code may mean a quantum error correction code that may protect information from a single bit flip error which occurs in the Pauli X channel. A structure of the 3-qubit bit flip code may be similar to a structure of a repetition code among existing error correction codes. The 3-qubit bit flip code encode one 1-qubit information into a space consisting of 3 qubits. For example, the 1-qubit information may be encoded into a space consisting of 3 qubits through an encoding process of Equation 7 below.

$$\vert 0 〉 \to \vert 000 〉 , \vert 1 〉 \to \vert 111 〉 \qquad [ Equation 7 ]$$

For example, any 1-qubit (|φ [symbol] =α|0 [symbol] +b|1 [symbol] ) information may be encoded into 3-qubit (|Ψ [symbol] =α|000 [symbol] +b|111 [symbol] ) information through an encoding process of Equation 11. An error may occur in a codeword encoded by a 3-qubit bit flip code during transmission to the receiving terminal through a single-bit flip error channel. The codeword encoded by the 3-qubit bit flip code may be transmitted to the receiving terminal in a state of one of Equations 8 to 11 below according to whether an error occurs and at an occurrence location of the error.

$$\vert {ψ}_{0} 〉 = a \vert 000 〉 + b \vert 111 〉 \qquad [ Equation 8 ]$$

$$\vert {ψ}_{1} 〉 = a \vert 100 〉 + b \vert 011 〉 \qquad [ Equation 9 ]$$

$$\vert {ψ}_{2} 〉 = a \vert 010 〉 + b \vert 101 〉 \qquad [ Equation 10 ]$$

$$\vert {ψ}_{3} 〉 = a \vert 001 〉 + b \vert 110 〉 \qquad [ Equation 11 ]$$

In Equations 8 to 11, |Ψ₀) may represent a case where no error occurs in the channel during transmission of the codeword encoded by the 3-qubit bit flip code, and |Ψ₁ [symbol] , |Ψ₂ [symbol] and |Ψ₃ [symbol] may represent cases where bit flip errors occur in 1st, 2nd, and 3rd qubits, respectively, during transmission of the codeword encoded by the 3-qubit bit flip code.

The codeword encoded by the 3-qubit bit flip code may be a vector existing in an orthogonal subspace depending on the location where the error occurs. Therefore, by projecting the transmitted information into the subspaces that are orthogonal to each other, it is possible to confirm whether the error occurs and the occurrence location of the error.

### 3-Qubit Phase Flip Error Code

FIG. 34 is a conceptual view illustrating an error correction circuit of a 3-qubit phase flip code applicable to the present disclosure.

Referring to FIG. 34, the 3-qubit bit flip code may mean a quantum error correction code that protects information from the single phase flip error which occurs in the Pauli X channel. A constitution of the 3-qubit phase flip code may be similar to a constitution of the 3-qubit bit flip code. The codeword of the 3-qubit phase flip code exists in a space consisting of |+++ [symbol] and |+++ [symbol] , and a state of |+ [symbol] and a state of |− [symbol] may be represented as in Equations 12 and 13 below.

$$\vert + 〉 = \frac{1}{2} ( \vert 0 〉 + \vert 1 〉 ) \qquad [ Equation 12 ]$$

$$\vert - 〉 = \frac{1}{2} ( \vert 0 〉 - \vert 1 〉 ) \qquad [ Equation 13 ]$$

Therefore, any 1-qubit state may be encoded as |Ψ [symbol] =α|+++ [symbol] +b|−−− [symbol] by the 3-qubit phase flip code. The |+ [symbol] state and the |− [symbol] state may have a relationship to be flipped to each other by a Z operator. This may be similar to |0 [symbol] and |1 [symbol] being flipped by an X operator.

### Shor Code

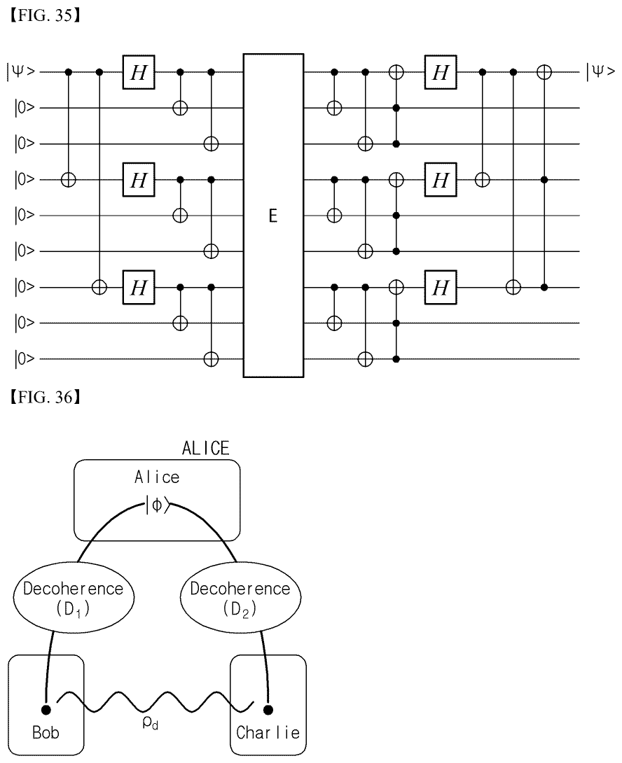

FIG. 35 is a conceptual view showing an error correction circuit of a Shor code applicable to the present disclosure.

Referring to FIG. 35, an encoding process of the Shor code may be performed by performing the encoding process of the 3-qubit phase flip code and then applying a 3-qubit bit flip process to each qubit. A decoding process of the Shor code may be performed by individually determining the bit flip error and the phase flip error that occur in the channel and correcting each error, thereby correcting all errors.

### Probabilistic Quantum Teleportation

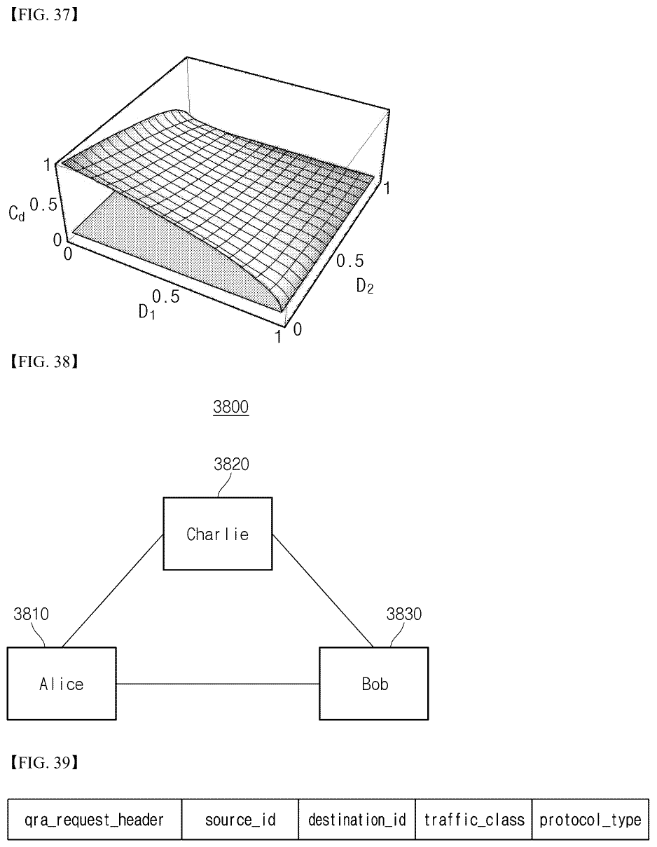

FIGS. 36 to 37 are conceptual diagrams illustrating probabilistic quantum teleportation.

The quantum teleportation protocol described above may use a maximally entangled state, such as the Bell state, as a medium for information transmission. However, generating a maximally entangled state may be highly inefficient. Due to the decoherence characteristics of quantum channels involved in the distribution process, the maximally entangled state may degrade into a partially entangled state. Referring to FIG. 36, for example, a maximally entangled state generated at Alice |Φ [symbol] may be delivered as a 2-qubit state ρ_{d} with reduced entanglement between Bob and Charlie due to the decoherence characteristics D₁, D₂ of the quantum channels.

Also, the maximally entangled state may lose its entanglement degree and degrade into a partially entangled state due to the decoherence characteristics of quantum devices involved in the distribution process. Referring to FIGS. 37, D1 and D2 may correspond to the decoherence characteristics of the quantum channels between Alice and Bob, and between Alice and Charlie, as well as the quantum devices forming those channels. For example, the quantum concurrence function C_{d} has a value of 1 for a maximally entangled state and may approach 0 as the entanglement degree decreases due to decoherence.

As illustrated in FIGS. 36 to 37, conventional quantum teleportation that relies solely on maximally entangled states as resources may not be readily applicable due to the decoherence characteristics of quantum channels and devices. Therefore, to overcome decoherence and utilize maximally entangled resources for quantum teleportation, processes such as entanglement distillation or entanglement concentration may be required. However, entanglement distillation or entanglement concentration may require significant resources.

To address the limitations of quantum teleportation that uses maximally entangled states as a medium of information transmission, various quantum teleportation protocols that use partially entangled states—such as the probabilistic quantum teleportation (PQT) protocol—have been proposed. The PQT protocol is based on the understanding that a partially entangled state may be considered a superposition of a maximally entangled state and a partially entangled state; the PQT protocol may be a protocol proposed to achieve quantum teleportation with a fidelity of 1 based on the maximally entangled state within the superposition of the maximally entangled state and the partially entangled state.

In the PQT protocol, the success of the quantum teleportation process may be determined through a process of local operation and classical communication (LOCC) using an ancillary qubit. If the quantum teleportation process is determined to be successful, the PQT protocol may teleport arbitrary qubit information with a fidelity of 1.

In quantum teleportation based on maximally entangled states, since the state of the qubit held by the receiver is determined by applying one of the four Pauli operators to the quantum state to be sent depending on the Bell state measurement result of the sender, quantum teleportation may be fully characterized using four distinct states.

Different from the description above, the PQT protocol may additionally require identification of cases in which the transmission fails. Therefore, in the PQT protocol, at least five distinct states need to be clearly distinguished. In the PQT protocol, it may not be possible to distinguish five states using a projection measurement on a two-qubit state space performed by the sender, as in the protocols based on maximally entangled states. Accordingly, the PQT protocol may introduce an ancillary qubit to perform measurement on a three-qubit state space. For example, to perform measurement on the three-qubit state space, the LOCC process may be required, such as the Unambiguous Quantum State Discrimination (UQSD) method performed by the sender (e.g., Alice) and the Extracting Quantum State (EQS) method performed by the receiver (e.g., Bob).

For example, the UQSD method and the EQS method may differ in terms of the entity performing the additional LOCC process required in the PQT protocol and the detailed steps of the LOCC process depending on the entity. However, the maximum value of the teleportation success probability achievable through the PQT protocol may be independent of the type of LOCC process. The maximum value of the teleportation success probability achievable through the PQT protocol may be determined by the probability density coefficient of the partially entangled state resources used in the PQT protocol. The partially entangled state used in the PQT protocol may be expressed by the mathematical expressions 14 to 15 below.

$$\vert {ϕ}_{AB}^{rsc} 〉 = a \vert {0}_{A} 〉 \vert {0}_{B} 〉 + b \vert {1}_{A} 〉 \vert {1}_{B} 〉 \qquad [ Equation 14 ]$$

$$\vert a \vert \geq \vert b \vert \qquad [ Equation 15 ]$$

In Equations 14 to 15,

$$\vert {ϕ}_{AB}^{rsc} 〉$$

may be the partially entangled state used in the PQT protocol, where A and B may respectively represent the qubits stored in the devices of the sender (e.g., Alice) and the receiver (e.g., Bob), and a and b may be complex-valued probability density coefficients that determine the entanglement degree of the partially entangled state. The maximum success probability and failure probability for quantum teleportation using the partially entangled state of Equations 14 to 15 may be given by Equations 16 to 17 below.

$${P}_{succ} = 2 {\vert b \vert}^{2} \qquad [ Equation 16 ]$$

$${P}_{fail} = ( 1 - 2 {\vert b \vert}^{2} ) \qquad [ Equation 17 ]$$

In Equations 16 to 17, p_{succ} may represent the maximum success probability of quantum teleportation using a partially entangled state, and P_{fail} may represent the failure probability. The early PQT protocol based on the UQSD or EQS method has a limitation in that quantum information is transmitted with a fidelity of 1 when teleportation is successful, but the quantum information is lost when teleportation fails. However, to overcome the limitation, a UQSD-based PQT protocol has been proposed, which avoids information loss by allowing the quantum information to remain in the original qubit in the event of teleportation failure; by utilizing the protocol, it may be possible to increase the success probability of quantum teleportation through multiple retransmission attempts in the event of teleportation failure.

In an environment where various traffic characteristics or target scenarios coexist, a mechanism may be additionally required, which adaptively manages the configuration information-including the probability density coefficient of the partially entangled state-according to the requirements of the quantum data to be transmitted via the PQT protocol and allocates the entanglement resources accordingly.

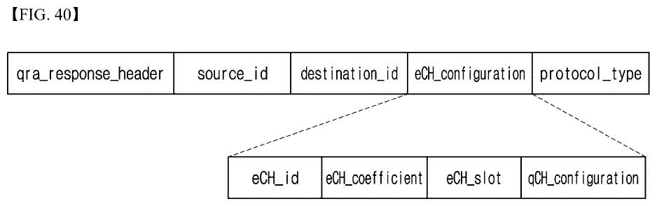

FIG. 38 is a diagram of a quantum communication system according to one embodiment of the present disclosure. FIG. 39 is a conceptual diagram of a quantum resource allocation request message according to one embodiment of the present disclosure. FIG. 40 is a conceptual diagram of a quantum resource allocation response message according to one embodiment of the present disclosure.

Referring to FIG. 38, a quantum communication system 3800 according to one embodiment of the present disclosure may include Alice 3810, Charlie 3820, and Bob 3830.

Alice 3810, Charlie 3820, and Bob 3830 may communicate with each other through a classical channel or a quantum channel. The quantum channel may include an entanglement channel (eCH) and a direct quantum channel (qCH). The entanglement channel may be an information delivery channel formed based on entanglement resources and may consist of a partially entangled state or a maximally entangled state. The direct quantum channel may be a channel that delivers information by directly transmitting a single photon and may consist of an optical fiber or free space.

Although the figure illustrates Alice 3810, Charlie 3820, and Bob 3830 as separate entities, Alice 3810 or Bob 3830 may include Charlie 3820 depending on the network architecture. If Alice 3810 includes Charlie 3820, the quantum communication system 3800 may correspond to downlink transmission in the classical communication; if Bob 3830 includes Charlie 3820, the quantum communication system 3810 may correspond to uplink transmission in the classical communication.

Alice 3810 may be a transmitting node that transmits quantum data based on resources in the partially entangled state, such as in the PQT protocol. When quantum data to be transmitted to Bob 3830 is generated, Alice 3810 may determine whether a resource is available for transmitting the quantum data. The quantum data to be transmitted to Bob 3830 may be quantum data that needs to be transmitted using partially entangled resources, and the resource may be a partially entangled resource.

If it is determined that a resource available for transmitting the quantum data exists, Alice 3810 may transmit the quantum data to Bob 3830 using the available resource. If it is determined that no resource is available, Alice 3810 may generate a quantum resource allocation (QRA) request message. The QRA request message may include information on the identifiers (IDs) of the transmitting and receiving nodes, traffic characteristic information, transmission protocol type, or indicators indicating the information. The identifiers of the transmitting and receiving nodes may be the identifiers of Alice 3810 and Bob 3830.

The traffic characteristic information may be configured based on requirements such as the maximum outage probability or maximum delay allowed to support the corresponding traffic type or scenario. In one embodiment, the traffic characteristic information may be related to a Quality of Service (QoS) identifier of traffic indicated by a higher layer, such as the QoS Class Identifier (QCI) of 4G/LTE or the QoS Identifier (QI) of 5G/NR. In another embodiment, the traffic characteristic information may be related to a target scenario considered at the physical layer and MAC layer to support traffic with specific requirements in terms of latency, throughput, and reliability, such as the mMTC, eMBB, or URLLC in 5G/NR.

Referring to FIG. 39, for example, the quantum resource allocation request message may include a qra_request_header field, a source_id field, a destination_id field, a traffic_class field, and a protocol_type field. The qra_request_header field may indicate that a packet corresponds to the quantum resource allocation request message. The source_id field may indicate the identifier of the transmitting node that intends to transmit quantum data using entanglement channel resources among quantum resources. For example, the transmitting node may be Alice 3810. The destination_id field may indicate the identifier of the receiving node that intends to receive quantum data using entanglement channel resources. For example, the receiving node may be Bob 3830. The traffic_class field may indicate traffic-specific characteristics such as required latency, reliability, and throughput. The protocol_type field may include transmission protocol information to be used for data transmission using the resources. For example, the resource may be a partially entangled resource, and the transmission protocol information may include information on the PQT protocol based on the UQSD scheme or the PQT protocol based on the EQS scheme.

Referring again to FIG. 38, Alice 3810 may transmit the quantum resource allocation request message to Charlie 3820. Alice 3810 may transmit the quantum resource allocation request message to Charlie 3820 via a classical channel.

Charlie 3820 may receive the quantum resource allocation request message from Alice 3810. Charlie 3820 may receive the quantum resource allocation request message from Alice 3810 via a classical channel. Based on the quantum resource allocation request message, Charlie 3820 may establish a quantum resource allocation (QRA) configuration. The QRA configuration may include entanglement information or probability density coefficient information of a quantum resource in the partially entangled state. The partially entangled state may be suitable for transmitting the quantum data that Alice 3810 intends to send to Bob 3830. Here, the data may be quantum data.

Charlie 3820 may set the QRA configuration by determining entanglement degree of the entanglement channel and configuration information necessary for the process of allocating entanglement channel resources generated based on the entanglement degree between Alice 3810 and Bob 3830. The entanglement degree may be determined based on the traffic characteristic information included in the quantum resource allocation request message. The entanglement channel resource may be allocated by directly transmitting the quantum resource via a direct quantum channel between Alice 3810 and Charlie 3820 or between Alice 3810 and Bob 3830. The configuration information may include, but is not limited to, entanglement degree and physical configuration information such as time or wavelength required for allocating the entanglement channel resource.

For example, in the case of the PQT protocol based on the UQSD scheme, Charlie 3820 may select a slot time of the quantum channel to determine the entanglement degree of the entanglement channel resource as configuration information of the entanglement channel resource allocated between Alice 3810 and Bob 3830. The slot time of the quantum channel may be determined based on the traffic_class field included in the quantum resource allocation request message. Charlie 3820 may derive the maximum number of transmissions allowed within the maximum delay based on the slot time. Charlie 3820 may obtain the maximum delay from the traffic_class included in the quantum resource allocation request message. Charlie 3820 may derive the maximum number of transmissions allowed within the maximum delay based on Equation 18 below.

$${N}_{max} = ⌊ \frac{{T}_{D}^{max}}{{T}_{slot}} ⌋ \qquad [ Equation 18 ]$$

Nₘₐₓ may be the maximum number of transmissions allowed within the maximum delay,

$${T}_{D}^{max}$$

may be the maximum delay, and Tₛₗₒₜ may be the slot time.

Charlie 3820 may determine the entanglement degree of the entanglement channel resource based on the maximum number of transmissions and the maximum outage probability allowed with the maximum delay. Charlie 3820 may obtain the maximum outage probability from traffic_class included in the quantum resource allocation request message. Charlie 3820 may determine the entanglement degree of the entanglement channel resource based on Equation 18.

$$\vert b \vert = \frac{1}{2} {( 1 - {( {P}_{out}^{max} )}^{\frac{1}{{N}_{max}}} )}^{1 / 2} \qquad [ Equation 19 ]$$

b may be the probability density coefficient of the entanglement channel resource, and

$${P}_{out}^{max}$$

may be the maximum outage probability. The maximum value of b may be

$$\sqrt{\frac{1}{2}} ( or \sqrt{\frac{1}{2}} - ε ) .$$

At this time, the entanglement channel resource may be in the maximally entangled state.

If the absolute value |b| of b is smaller than a threshold value, Charlie 3820 may determine that transmission via PQT is performed with a success probability greater than or equal to a preconfigured value. Here, the closer the value of b is to

$$\sqrt{\frac{1}{2}} ,$$

the higher the transmission probability of PQT may be. Charlie 3820 may obtain another probability density coefficient α of the entanglement channel resource based on Equations 14 to 15. When b has its maximum value of

$$\sqrt{\frac{1}{2}} ,$$

the value of a may be a value adjacent to the maximum value

$$\sqrt{\frac{1}{2}} .$$

If the absolute value |b| of b exceeds a threshold value, Charlie 3820 may determine that the PQT transmission probability is lower than a preset value. Charlie 3820 may update the configuration information of the entanglement channel resource and the maximum delay and may again perform operations on the probability density b of the entanglement channel resource. Charlie 3820 may continue to update the configuration information of the entanglement channel resource and the maximum delay, and repeatedly perform the operations on b, until the absolute value |b| of b becomes smaller than the threshold. Thereafter, Charlie 3820 may obtain another probability density coefficient α of the entanglement channel resource based on Equations 14 to 15. In this case, Charlie 3820 may configure the entanglement channel resources using a parallel structure.

Charlie 3820 may generate a first quantum resource allocation response message and a second quantum resource allocation response message based on the quantum resource allocation request message and the quantum resource allocation configuration information. The quantum resource allocation configuration information may include information related to the entanglement channel resource.

Referring to FIG. 40, for example, the first quantum resource allocation response message and the second quantum resource allocation response message may include a qra_response_header field, a source_id field, a destination_id field, an eCH_configuration field, and a protocol_type field.

The qra_response_header field may indicate that a packet corresponds to a quantum resource allocation response message. The source_id field may indicate the identifier of a transmitting node that intends to transmit quantum data using entanglement channel resources among quantum resources. For example, the transmitting node may be Alice 3810. The destination_id field may indicate the identifier of a receiving node that intends to receive quantum data using entanglement channel resources among quantum resources. For example, the receiving node may be Bob 3830.

The eCH_configuration field may include an eCH_id field, an eCH_coefficient field, an eCH_slot field, and a qCH_configuration field. When Charlie 3820 allocates multiple entanglement channel resources to Alice 3810 and Bob 3830, the eCH_id field, eCH_coefficient field, eCH_slot field, and qCH_configuration field may be configured as multiple entries corresponding to the multiple entanglement channel resources.

The eCH_id field may indicate the identifier of an entanglement channel resource. The particles of the entanglement channel resource may be paired with Alice 3810 and Bob 3830 based on the identifier of the entanglement channel resource. When multiple entanglement channel resources are allocated to Alice 3810 and Bob 3830, the multiple entanglement channel resources may be used in the order of their identifiers.

The eCH_coefficient field may indicate the probability density coefficients (e.g., a, b) of the entanglement channel resource. The eCH_coefficient field may be omitted based on the recipient and the transmission protocol of the first quantum resource allocation response message and the second quantum resource allocation response message.

For example, when the recipient of the first quantum resource allocation response message is Alice 3810 and the transmission protocol is the PQT protocol based on the UQSD method, the first quantum resource allocation response message may include the eCH_coefficient field, whereas the second quantum resource allocation response message may not include the eCH_coefficient field.

When the recipient of the first quantum resource allocation response message is Alice 3810 and the transmission protocol is the PQT protocol based on the EQS method, the first quantum resource allocation response message may not include the eCH_coefficient field, whereas the second quantum resource allocation response message may include the eCH_coefficient field.

The eCH_slot field may indicate the slot time information of the transmission protocol in which the entanglement channel resource is to be used. When multiple entanglement channel resources are mapped to the same slot, the multiple entanglement channel resources may be used in the order of their entanglement channel resource identifiers.

The qCH_configuration field may indicate configuration information of the direct quantum channel used when Charlie 3820 transmits the entanglement channel resource to Alice 3810 and Bob 3830. The configuration information of the direct quantum channel may include physical configuration information such as time or wavelength.

The protocol_type field may include information on the transmission protocol used for data transmission utilizing the resources. For example, the resources may be partially entangled resources, and the transmission protocol information may include information on the PQT protocol based on the UQSD method or information on the PQT protocol based on the EQS method.

Referring again to FIG. 38, Charlie 3820 may transmit the first quantum resource allocation response message to Alice 3810 and the second quantum resource allocation response message to Bob 3830. Charlie 3820 may transmit the first quantum resource allocation response message and the second quantum allocation response message through the classical channel.

Also, Charlie 3820 may generate an entanglement channel resource based on the quantum resource allocation configuration information. The quantum resource allocation configuration information may include information on the entanglement channel resource. Charlie 3820 may generate a quantum resource based on the processes such as entanglement generation and entanglement concentration. Charlie 3820 may allocate the entanglement channel resource to Alice 3810 and Bob 3830.

Bob 3830 may receive the second quantum resource allocation response message from Charlie 3820. When the transmission protocol is the PQT protocol based on the UQSD method, the second quantum resource allocation response message may not include the entanglement degree or the probability density coefficient of the entanglement channel resource. When the transmission protocol is the PQT protocol based on the EQS method, the second quantum resource allocation response message may include the entanglement degree or the probability density coefficient of the entanglement channel resource. Also, Charlie 3820 may allocate the entanglement channel resource to Bob 3830.

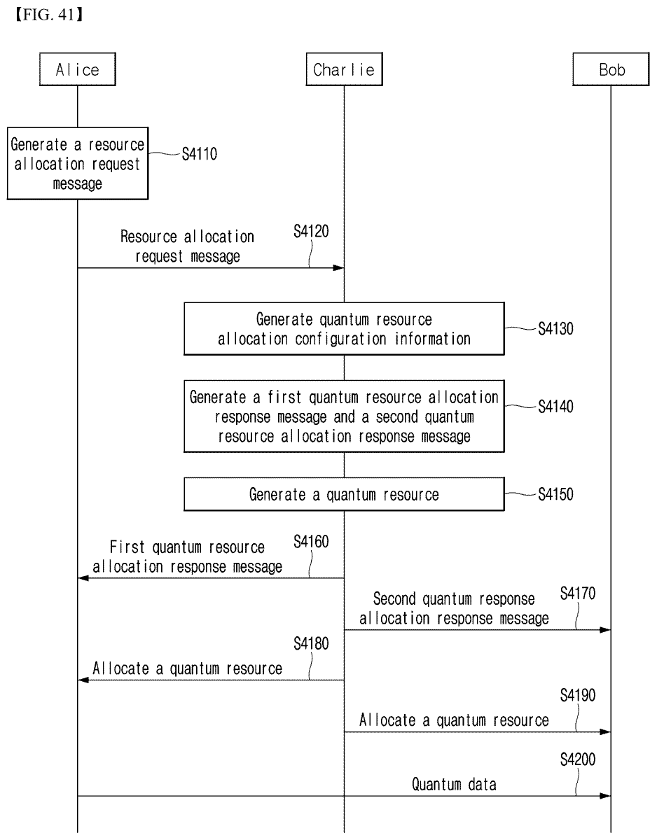

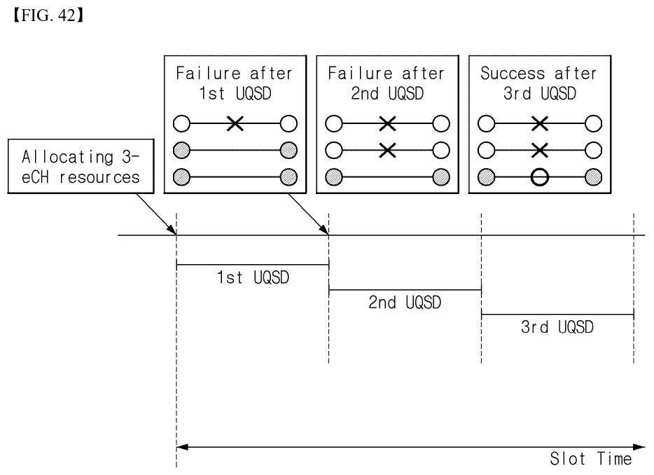

FIG. 41 is a flowchart of a quantum communication method according to one embodiment of the present disclosure.

The embodiment of FIG. 41 may include, prior to the S4110 step, a step in which Charlie (e.g., Charlie 3820 of FIG. 38) transmits one or more synchronization signals to Alice (e.g., Alice 3810 of FIG. 38) and Bob (e.g., Bob 3830 of FIG. 38), a step in which Alice and Bob receive the one or more synchronization signals from Charlie, a step in which Charlie transmits system information to Alice and Bob, and a step in which Alice and Bob receive the system information from Charlie.

Also, the embodiment of FIG. 41 may further include, prior to the S4110 step, a step in which Alice and Bob transmit random access preambles to Charlie, a step in which Charlie receives the random access preambles from Alice and Bob, a step in which Charlie transmits a random access response to Alice and Bob, a step in which Alice and Bob receive the random access response from Charlie, a step in which Charlie transmits control information to Alice and Bob, and a step in which Alice and Bob receive the control information from Charlie.

Referring to FIG. 41, Alice may generate a quantum resource allocation request message S4110. Alice (e.g., Alice 3810 of FIG. 38) may generate the quantum resource allocation request message when quantum data to be transmitted to Bob (e.g., Bob 3830 of FIG. 38) is generated but no resources are available for transmitting the quantum data. Here, the resource may be an entangled resource.

The quantum resource allocation request message may include, but is not limited to, identifier information of Alice, identifier information of Bob, traffic characteristic information, transmission protocol information, indicators for indicating the corresponding information, or information on physical characteristics that may indicate the corresponding information. Also, the traffic characteristic information may be related to at least one of the maximum outage probability or the maximum delay. Alice may transmit the quantum resource allocation request message to Charlie S4120.

Charlie may receive the quantum resource allocation request message from Alice S4120. Charlie may generate quantum resource allocation configuration information based on the quantum resource allocation request message S4130. Charlie may obtain entanglement information or probability density coefficients of the quantum resources in the partially entangled state based on the traffic characteristic information included in the quantum resource allocation request message. Here, the quantum resource may be the entanglement channel resource. Charlie may generate the quantum resource allocation configuration information including the entanglement information or probability density coefficients of the quantum resources in the partially entangled state.

Charlie may generate a first quantum resource allocation response message and a second quantum resource allocation response message S4140. Charlie may generate the first quantum resource allocation response message and the second quantum resource allocation response message based on the quantum resource allocation request message received in the S4120 step and the quantum resource allocation configuration information generated in the S4130 step.

The first quantum resource allocation response message and the second quantum resource allocation response message may include identifier information of Alice, identifier information of Bob, entanglement channel configuration information, and information related to the transmission protocol.

The entanglement channel configuration information may vary depending on the recipients of the first quantum resource allocation response message and the second quantum resource allocation response message, and the transmission protocol. For example, when the recipients of the first and second quantum resource allocation response messages are Alice and Bob, respectively, and the transmission protocol is the PQT protocol based on the UQSD method, the entanglement channel configuration information may include the identifier of the entanglement channel resource of the first quantum resource allocation response message, slot time information, direct quantum channel configuration information, and the probability density coefficient of the entanglement channel resource. The entanglement channel configuration information of the second quantum resource allocation response message may include the identifier of the entanglement channel resource, slot time information, and direct quantum channel configuration information but may not include the probability density coefficient of the entanglement channel resource.

For example, when the recipients of the first and second quantum resource allocation response messages are Alice and Bob, respectively, and the transmission protocol is the PQT protocol based on the EQS method, the entanglement channel configuration information may include the identifier of the entanglement channel resource of the first quantum resource allocation response message, slot time information, and direct quantum channel configuration information but may not include the probability density coefficient of the entanglement channel resource. The entanglement channel configuration information in the second quantum resource allocation response message may include the identifier of the entanglement channel resource, slot time information, direct quantum channel configuration information, and the probability density coefficient of the entanglement channel resource.

Charlie may generate quantum resources based on the quantum resource allocation configuration S4150. Charlie may generate quantum resources based on the quantum resource allocation configuration information. Charlie may generate quantum resources by performing at least one of entanglement generation or entanglement concentration based on the quantum resource allocation configuration information. The quantum resources may be entanglement channel resources.

Charlie may transmit the first quantum resource allocation response message to Alice S4160. Charlie may transmit the second quantum resource allocation response message to Bob S4170. Charlie may transmit the first and second quantum resource allocation response messages to Alice and Bob, respectively, via a classical channel.

Also, Charlie may allocate quantum resources to Alice S4180. Charlie may allocate quantum resources to Bob S4190. Charlie may allocate quantum resources to Alice and Bob via a direct quantum channel.

Alice may receive the first quantum resource allocation response message from Charlie S4160 and may receive quantum resources from Charlie S4180. Bob may receive the second quantum resource allocation response message from Charlie S4170. Bob may receive quantum resources from Charlie S4190.

Alice and Bob may receive the first and second quantum resource allocation response messages from Charlie via a classical channel. Alice and Bob may receive quantum resources from Charlie via a direct quantum channel.

Alice may transmit quantum data to Bob based on the first quantum resource allocation response message and the quantum resources S4200. Bob may receive the quantum data from Alice based on the second quantum resource allocation response message and the quantum resources S4200. Here, the quantum data may be PQT. For example, in the case of a lossless UQSD-based PQT protocol, the PQT transmission may be illustrated as shown in FIG. 41.

FIG. 42 is a conceptual diagram illustrating PQT transmission according to one embodiment of the present disclosure.

Referring to FIG. 42, when three entanglement channel resources are allocated, Alice (e.g., Alice 3830 in FIG. 38) may perform PQT transmission based on the UQSD scheme three times within a single slot.

Alice (e.g., Alice 3810 in FIG. 38) may transmit PQT to Bob (e.g., Bob 3830 in FIG. 38) based on the first entanglement channel resource (1st UQSD). Alice may determine whether the PQT transmission based on the first entanglement channel resource is successful. For example, Alice may perform the local operation required for the UQSD scheme and measure the ancillary qubit to determine whether the PQT transmission based on the first entanglement channel resource is successful.

If the PQT transmission based on the first entanglement channel resource is successful, Alice may transmit information on the PQT transmission based on the first entanglement channel resource and information on the first entanglement channel resource to Bob. If the PQT transmission based on the first entanglement channel resource fails, Alice may transmit PQT to Bob using the second entanglement channel resource (2nd UQSD). Alice may determine whether the PQT transmission based on the second entanglement channel resource is successful.

If the PQT transmission based on the second entanglement channel resource is successful, Alice may transmit information on the PQT transmission based on the second entanglement channel resource and information on the second entanglement channel resource to Bob. If the PQT transmission based on the second entanglement channel resource fails, Alice may transmit PQT to Bob based on the third entanglement channel resource (3rd UQSD). Alice may determine whether the PQT transmission based on the third entanglement channel resource is successful. For example, Alice may perform the local operation required for the UQSD scheme and measure the ancillary qubit to determine whether the PQT transmission based on the third entanglement channel resource is successful.

If the PQT transmission based on the third entanglement channel resource is successful, Alice may transmit information on the PQT transmission based on the third entanglement channel resource and information on the third entanglement channel resource to Bob. If the PQT transmission based on the third entanglement channel resource fails, Alice may terminate the PQT transmission within the slot. Alice may transmit information indicating the failure of the PQT transmission to Bob.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method performed by a first node, the method comprising:
receiving at least one synchronization signal from a second node;
receiving system information from the second node;
transmitting a random access preamble to the second node;
receiving a random access response message from the second node;
transmitting, to the second node, a quantum resource allocation request message including traffic characteristic information;
receiving, from the second node, a quantum resource allocation response message including quantum resource allocation configuration information;
receiving an allocation of a quantum resource from the second node based on a direct quantum channel; and
transmitting data to a third node based on the quantum resource allocation response message and the quantum resource,
wherein the quantum resource allocation configuration information includes entanglement information or probability density coefficients of partially entangled quantum resources.

2. The method of claim 1, wherein the traffic characteristic information relates to at least one of maximum outage probability or maximum delay.

3. The method of claim 1, wherein the quantum resource allocation request message further includes at least one of identifier information of the first node, identifier information of the third node, or information for a transmission protocol type.

4. The method of claim 1, wherein the transmitting data to the third node based on the quantum resource transmits the data contiguously based on the quantum resource.

5. A first node comprising:
one or more transceivers;
one or more processors controlling the one or more transceivers; and
one or more memories including one or more instructions performed by the one or more processors,
wherein the one or more instructions comprise:
receiving at least one synchronization signal from a second node;
receiving system information from the second node;
transmitting a random access preamble to the second node;
receiving a random access response message from the second node;
transmitting, to the second node, a quantum resource allocation request message including traffic characteristic information;
receiving, from the second node, a quantum resource allocation response message including quantum resource allocation configuration information;
receiving an allocation of a quantum resource from the second node based on a direct quantum channel; and
transmitting data to a third node based on the quantum resource allocation response message and the quantum resource,
wherein the quantum resource allocation configuration information includes entanglement information or probability density coefficients of partially entangled quantum resources.

6. The first node of claim 5, wherein the traffic characteristic information relates to at least one of maximum outage probability or maximum delay.

7. The first node of claim 5, wherein the quantum resource allocation request message further includes at least one of identifier information of the first node, identifier information of the third node, or information for a transmission protocol type.

8. The first node of claim 5, wherein the transmitting data to the third node based on the quantum resource transmits the data contiguously based on the quantum resource.

9. A first node comprising:
one or more transceivers;
one or more processors controlling the one or more transceivers; and
one or more memories including one or more instructions performed by the one or more processors,
wherein the one or more instructions comprise:
transmitting at least one synchronization signal to a second node and a third node;
transmitting system information to the second node and the third node;
receiving a random access preamble from the second node and the third node;
transmitting a random access response message to the second node and the third node;
receiving, from the second node, a quantum resource allocation response message including traffic characteristic information;
determining quantum resource allocation configuration information based on the traffic characteristic information;
generating a first response message and a second response message that include the quantum resource allocation configuration information in response to the quantum resource allocation request message;
transmitting the first response message to the second node;
transmitting the second response message to the third node;
generating a quantum resource based on the quantum resource allocation configuration; and
allocating the quantum resource to the second node and the third node based on a direct quantum channel.

10. The first node of claim 9, wherein the quantum resource allocation request message further includes at least one of identifier information of the second node, identifier information of the third node, or information for a transmission protocol type.

11. The first node of claim 9, wherein determining the quantum resource allocation configuration information based on the traffic characteristic information comprises:
obtaining entanglement information or probability density coefficients of a quantum resource in a partially entangled state; and
determining the quantum resource allocation configuration information including the entanglement information or the probability density coefficients of the quantum resource in the partially entangled state.

12. The first node of claim 9, wherein information included in the first response message and the second response message is determined based on a transmission protocol between the second node and the third node.

13. The first node of claim 9, wherein the generating the quantum resource based on the quantum resource allocation configuration information includes generating the quantum resource by performing at least one of entanglement generation or entanglement concentration based on the quantum resource allocation configuration information.

14-20. (canceled)
